(19) United States
(12) Patent Application Publication
(10) Pub. No.: US 2022/0326058 A1
(43) Pub. Date: Oct. 13, 2022

(54) MEASUREMENT CONTROL DEVICE

(71) Applicant: DENSO CORPORATION, Kariya-city (JP)

(72) Inventors: Hiroyuki AKUZAWA, Kariya-city (JP); Taichi WATANABE, Kariya-city (JP); Amane HIGASHI, Kariya-city (JP)

(21) Appl. No.: 17/847,626

(22) Filed: Jun. 23, 2022

Related U.S. Application Data
(63) Continuation of application No. PCT/JP2020/045682, filed on Dec. 8, 2020.

(30) Foreign Application Priority Data
Dec. 25, 2019 (JP) 2019-235221

(51) Int. Cl. G01F 1/72; G01F 1/69

(52) U.S. Cl. CPC G01F 1/72; G01F 1/69

(57) ABSTRACT

A measurement control device includes: a sensing unit that outputs a signal according to an air flow rate; a pulsation state calculation unit that calculates a pulsation state of pulsation generated in the air flow rate using an output value of the sensing unit; and a pulsation error correction unit that corrects the air flow rate. The pulsation state calculation unit has an upper extreme value determination unit and a frequency calculation unit. The upper extreme value determination unit cancels the upper extreme value that has presently appeared, when the output value remains to be more than a predetermined lower threshold. The upper extreme value determination unit updates the lower threshold on a basis of at least one of air flow rate, pulsation frequency, or pulsation amplitude specified on the basis of the output value.

### CROSS REFERENCE TO RELATED APPLICATION

The present application is a continuation application of International Patent Application No. PCT/JP2020/045682 filed on Dec. 8, 2020, which designated the U.S. and claims the benefit of priority from Japanese Patent Application No. 2019-235221 filed on Dec. 25, 2019. The entire disclosures of all of the above applications are incorporated herein by reference.

### TECHNICAL FIELD

The present disclosure relates to a measurement control device.

### BACKGROUND ART

A device for measuring an air flow rate includes an electronic control unit, and the electronic control unit calculates the air flow rate on the basis of an output value of an air flow sensor.

### SUMMARY

A measurement control device includes: a sensing unit that outputs a signal according to an air flow rate; a pulsation state calculation unit that calculates a pulsation state of pulsation generated in the air flow rate using an output value of the sensing unit; and a pulsation error correction unit that corrects the air flow rate. The pulsation state calculation unit has: an upper extreme value determination unit that determines whether the output value has become an upper extreme value; and a frequency calculation unit that calculates a pulsation frequency of the pulsation generated in the air flow rate on a basis of a time interval at which the output value becomes the upper extreme value. The upper extreme value determination unit cancels the upper extreme value that has presently appeared, when the output value remains to be more than a predetermined lower threshold during a period from a timing when the upper extreme value has previously appeared to a timing when the upper extreme value has presently appeared in a waveform representing a time change of the output value. Further, the upper extreme value determination unit updates the lower threshold on a basis of at least one of air flow rate, pulsation frequency, or pulsation amplitude specified on the basis of the output value.

### BRIEF DESCRIPTION OF DRAWINGS

FIG. 1 is a perspective view of an air flow meter according to a first embodiment as viewed from an upstream side.

FIG. 2 is a perspective view of the air flow meter as viewed from a downstream side.

FIG. 3 is a vertical cross-sectional view of the air flow meter attached to an intake pipe.

FIG. 4 is a cross-sectional view taken along line IV-IV of FIG. 3.

FIG. 5 is a cross-sectional view taken along line V-V of FIG. 3.

FIG. 6 is a block diagram illustrating a schematic configuration of the air flow meter.

FIG. 7 is a block diagram illustrating a schematic configuration of a correction circuit according to the first embodiment.

FIG. 8 is a diagram for describing a method of calculating an interval between upper extreme values.

FIG. 9 is a diagram for describing a method of calculating an average air amount.

FIG. 10 is a diagram for describing a method of calculating a pulsation amplitude.

FIG. 11 is a diagram illustrating a relationship between pulsation characteristics and approximate values.

FIG. 12 is a diagram illustrating a map.

FIG. 13A is a diagram for describing a calculation method of the average air amount after correction.

FIG. 13B is a diagram for describing determination of an upper extreme value when a sampling value at present time remains to be more than a lower threshold.

FIG. 13C is a diagram illustrating an example in which an output value of a sensing unit becomes equal to or less than the lower threshold due to influence of harmonics, and an upper extreme value is not canceled and is erroneously detected as the upper extreme value.

FIG. 13D is a diagram illustrating an example of a case where a steep output change occurs in the output value of the sensing unit and the output value becomes higher without becoming equal to or less than the lower threshold.

FIG. 13E is a diagram for describing a map in which a pulsation amplitude, a pulsation frequency, and an average air amount are associated with a reference value of a lower threshold.

FIG. 13F is a flowchart of an upper extreme value determination unit.

FIG. 13G is a diagram illustrating a modification of a map.

FIG. 14 is a block diagram illustrating a schematic configuration of a correction circuit according to a second embodiment.

FIG. 15 is a diagram for exemplifying noise contained in the output value.

FIG. 16 is a diagram for describing a method of cutting a minus value of an output value.

FIG. 17 is a block diagram illustrating a schematic configuration of a correction circuit according to a third embodiment.

FIG. 18A is a diagram for describing a calculation method of an interval of upper extreme values.

FIG. 18B is a diagram for describing a method of updating a lower threshold of an upper extreme value determination unit of a correction circuit according to a fifth embodiment.

FIG. 18C is a diagram illustrating how the output value and the lower extreme value of the sensing unit of the correction circuit in the fifth embodiment change.

FIG. 18D is a flowchart of an upper extreme value determination unit in a sixth embodiment.

FIG. 18E is a diagram illustrating how the output value and the lower extreme value of the sensing unit of the correction circuit in the sixth embodiment change.

### DESCRIPTION OF EMBODIMENTS

To begin with, examples of relevant techniques will be described.

As a configuration for measuring an air flow rate, an electronic control unit (ECU) that controls an internal combustion engine calculates an air flow rate on the basis of an output value of an air flow sensor. In addition to a detection signal of the air flow sensor, a detection signal of a crank angle sensor that detects an engine speed is input to this ECU. The ECU calculates a pulsation frequency of the air flow rate using the engine speed detected by the crank angle sensor, and corrects the air flow rate using this pulsation frequency so as to reduce pulsation errors, which are errors caused by pulsation of the air flow rate.

However, since the ECU performs a correction process for the air flow rate in addition to a control process of the internal combustion engine, it is assumed that a processing load of the ECU is excessively increased. Accordingly, a configuration is conceivable in which the correction process for the air flow rate is executed by a measurement control device independent of the ECU, and this measurement control device outputs a correction result of the air flow rate to the ECU. In this configuration, the ECU can acquire the correction result of the air flow rate, and moreover, the processing load of the ECU can be reduced.

However, even in this configuration, if the measurement control device uses the engine speed when calculating the pulsation state such as the pulsation frequency, the ECU needs to output rotation speed information indicating the engine speed to the measurement control device. In this manner, when the measurement control device uses the rotation speed information from the ECU to correct the air flow rate, there is a concern that correction accuracy of the air flow rate may decrease due to noise included in the rotation speed information, and the like.

Accordingly, it is conceivable that a pulsation state that is a state of pulsation generated in the air flow rate is calculated using an output value of a sensing unit in the air flow sensor instead of being acquired from an external ECU, and the air flow rate is corrected using this pulsation state.

Then, for example, the output value when a change of the output value switches from increase to decrease is detected as an upper extreme value, and the pulsation frequency is calculated on the basis of a time interval in which the output value becomes the upper extreme value. Alternatively, the output value when a change of the output value switches from decrease to increase is detected as a lower extreme value, and the pulsation frequency is calculated on the basis of the time interval at which the output value becomes the lower extreme value. The air flow rate is corrected on the basis of the pulsation state including the pulsation frequency.

However, when the output value changes abruptly due to influence of harmonics or sudden changes in the air flow rate, or the like, the upper extreme value or the lower extreme value may be erroneously detected. In this case, the correction accuracy of the air flow rate may deteriorate.

The present disclosure provides a measurement control device to improve the correction accuracy of the air flow rate.

According to an aspect of the present disclosure, a measurement control device includes: a sensing unit that outputs a signal according to an air flow rate; a pulsation state calculation unit that calculates a pulsation state that is a state of pulsation generated in the air flow rate using an output value of the sensing unit; and a pulsation error correction unit that corrects the air flow rate using the pulsation state calculated by the pulsation state calculation unit. The pulsation state calculation unit has: an upper extreme value determination unit that, when the output value when a change mode of the output value switches from increase to decrease is referred to as an upper extreme value, determines whether the output value has become the upper extreme value; and a frequency calculation unit that calculates a pulsation frequency of the pulsation generated in the air flow rate on a basis of a time interval at which the output value becomes the upper extreme value, and calculates the pulsation state including the pulsation frequency. The upper extreme value determination unit, when the output value remains to be more than a predetermined lower threshold during a period from a timing when the upper extreme value has previously appeared to a timing when the upper extreme value has presently appeared in a waveform representing a time change of the output value, negatively determines and cancels the upper extreme value that has presently appeared, and further updates the lower threshold on a basis of at least one of the air flow rate specified on a basis of the output value, the pulsation frequency, or a pulsation amplitude specified on the basis of the output value.

With such a configuration, the lower threshold is updated on the basis of at least one of the air flow rate specified on the basis of the output value, the pulsation frequency, and the pulsation amplitude specified on the basis of the output value, and thus false detection of the upper extreme value is reduced. Therefore, the correction accuracy of the air flow rate can be improved.

According to another aspect of the present disclosure, a measurement control device includes: a sensing unit that outputs a signal according to an air flow rate; a pulsation state calculation unit that calculates a pulsation state that is a state of pulsation generated in the air flow rate using an output value of the sensing unit; and a pulsation error correction unit that corrects the air flow rate using the pulsation state calculated by the pulsation state calculation unit. The pulsation state calculation unit has: an upper extreme value determination unit that, when the output value when a change mode of the output value switches from increase to decrease is referred to as an upper extreme value, determines whether the output value has become the upper extreme value; and a frequency calculation unit that calculates a pulsation frequency of the pulsation generated in the air flow rate on a basis of a time interval at which the output value becomes the upper extreme value, and calculates the pulsation state including the pulsation frequency. The upper extreme value determination unit, when the output value remains to be more than a predetermined lower threshold during a period from a timing when the upper extreme value has previously appeared to a timing when the upper extreme value has presently appeared in a waveform representing a time change of the output value, negatively determines and cancels the upper extreme value that has presently appeared, and further updates the lower threshold on a basis of a reference value of the lower threshold that changes according to the pulsation state.

With such a configuration, the lower threshold is updated on the basis of the reference value of the lower threshold that changes according to the pulsation state, and thus false detection of the upper extreme value is reduced. Therefore, the correction accuracy of the air flow rate can be improved.

According to another aspect of the present disclosure, a measurement control device includes: a sensing unit that outputs a signal according to an air flow rate; a pulsation state calculation unit that calculates a pulsation state that is a state of pulsation generated in the air flow rate using an output value of the sensing unit; and a pulsation error correction unit that corrects the air flow rate using the pulsation state calculated by the pulsation state calculation unit. The pulsation state calculation unit has: an upper extreme value determination unit that, when the output value when a change mode of the output value switches from increase to decrease is referred to as an upper extreme value, determines whether the output value has become the upper extreme value; and a frequency calculation unit that calculates a pulsation frequency of the pulsation generated in the air flow rate on a basis of a time interval at which the output value becomes the upper extreme value, and calculates the pulsation state including the pulsation frequency. The upper extreme value determination unit, when the output value remains to be more than a predetermined lower threshold during a period from a timing when the upper extreme value has previously appeared to a timing when the upper extreme value has presently appeared in a waveform representing a time change of the output value, negatively determines and cancels the upper extreme value that has presently appeared, and further updates the lower threshold by using the lower threshold used for determining the upper extreme value in a period from before a predetermined period to the timing when the upper extreme value has presently appeared.

With such a configuration, the lower threshold is updated by using the lower threshold used for determining the upper extreme value in the period from before the predetermined period to the timing when the upper extreme value has presently appeared, so that the false detection of the upper extreme value is reduced. Therefore, the correction accuracy of the air flow rate can be improved.

According to another aspect of the present disclosure, a measurement control device includes: a sensing unit that outputs a signal according to an air flow rate; a pulsation state calculation unit that calculates a pulsation state that is a state of pulsation generated in the air flow rate using an output value of the sensing unit; and a pulsation error correction unit that corrects the air flow rate using the pulsation state calculated by the pulsation state calculation unit. The pulsation state calculation unit has a lower extreme value determination unit that, when the output value when a change mode of the output value switches from decrease to increase is referred to as a lower extreme value, determines whether the output value has become the lower extreme value. The lower extreme value determination unit, when the output value remains to be less than a predetermined upper threshold during a period from a timing when the lower extreme value has previously appeared to a timing when the lower extreme value has presently appeared in a waveform representing a time change of the output value, negatively determines and cancels the lower extreme value that has presently appeared, and further updates the upper threshold on a basis of at least one of the air flow rate specified on a basis of the output value, a pulsation frequency specified on the basis of the output value, or a pulsation amplitude specified on the basis of the output value.

With such a configuration, the upper threshold is updated on the basis of at least one of the air flow rate specified on the basis of the output value, the pulsation frequency specified on the basis of the output value, or the pulsation amplitude specified on the basis of the output value, and thus false detection of the lower extreme value is reduced. Therefore, the correction accuracy of the air flow rate can be improved.

According to another aspect of the present disclosure, a measurement control device includes: a sensing unit that outputs a signal according to an air flow rate; a pulsation state calculation unit that calculates a pulsation state that is a state of pulsation generated in the air flow rate using an output value of the sensing unit; and a pulsation error correction unit that corrects the air flow rate using the pulsation state calculated by the pulsation state calculation unit. The pulsation state calculation unit has: a lower extreme value determination unit that, when the output value when a change mode of the output value switches from decrease to increase is referred to as a lower extreme value, determines whether the output value has become the lower extreme value; and a frequency calculation unit that calculates a pulsation frequency of the pulsation generated in the air flow rate on a basis of a time interval at which the output value becomes the lower extreme value, and calculates the pulsation state including the pulsation frequency. The lower extreme value determination unit, when the output value remains to be less than a predetermined upper threshold during a period from a timing when the lower extreme value has previously appeared to a timing when the lower extreme value has presently appeared in a waveform representing a time change of the output value, negatively determines and cancels the lower extreme value that has presently appeared, and further updates the upper threshold on a basis of a reference value of the upper threshold that changes according to the pulsation state.

With such a configuration, the upper threshold is updated on the basis of the reference value of the upper threshold that changes according to the pulsation state, and thus erroneous detection of the lower extreme value is reduced. Therefore, the correction accuracy of the air flow rate can be improved.

According to another aspect of the present disclosure, a measurement control device includes: a sensing unit that outputs a signal according to an air flow rate; a pulsation state calculation unit that calculates a pulsation state that is a state of pulsation generated in the air flow rate using an output value of the sensing unit; and a pulsation error correction unit that corrects the air flow rate using the pulsation state calculated by the pulsation state calculation unit. The pulsation state calculation unit has: a lower extreme value determination unit that, when the output value when a change mode of the output value switches from decrease to increase is referred to as a lower extreme value, determines whether the output value has become the lower extreme value; and a frequency calculation unit that calculates a pulsation frequency of the pulsation generated in the air flow rate on a basis of a time interval at which the output value becomes the lower extreme value, and calculates the pulsation state including the pulsation frequency. The lower extreme value determination unit, when the output value remains to be less than a predetermined upper threshold during a period from a timing when the lower extreme value has previously appeared to a timing when the lower extreme value has presently appeared in a waveform representing a time change of the output value, negatively determines and cancels the lower extreme value that has presently appeared, and further updates the upper threshold by using the upper threshold used for determining the lower extreme value in a period from before a predetermined period to the timing when the lower extreme value has presently appeared.

With such a configuration, the upper threshold is updated by using the upper threshold used for determining the lower extreme value in the period from before the predetermined period to the timing when the lower extreme value has presently appeared, and thus false detection of the lower extreme value is reduced. Therefore, the correction accuracy of the air flow rate can be improved.

Reference numerals attached to respective components and the like indicate an example of a correspondence relationship between the components and the like and specific components and the like described in embodiments described later.

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### (First Embodiment)

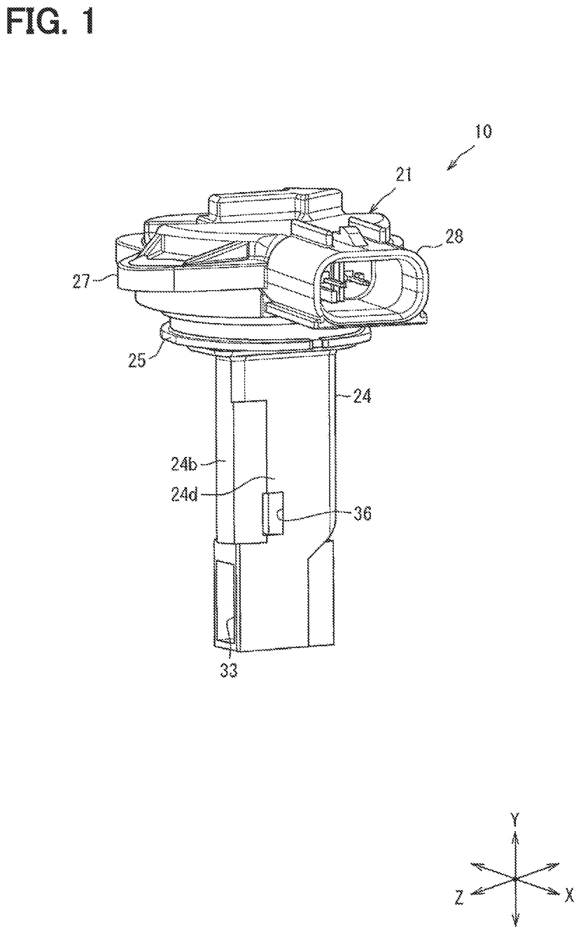

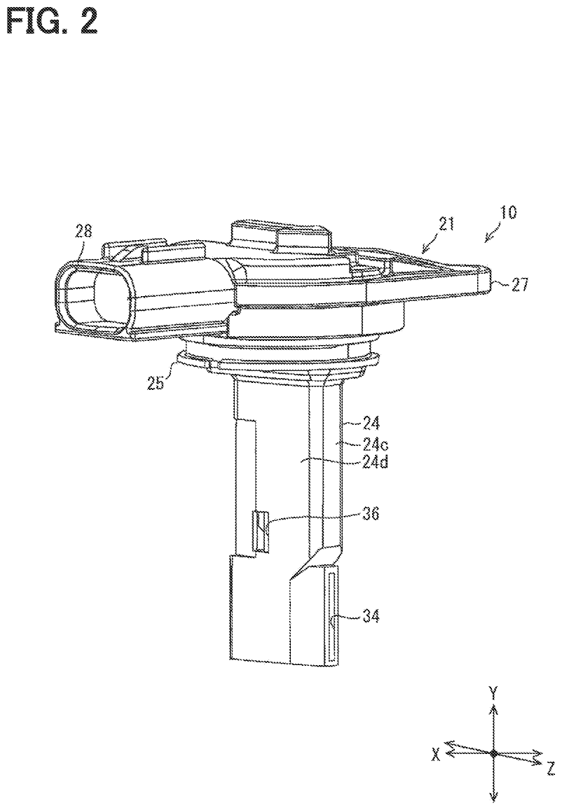

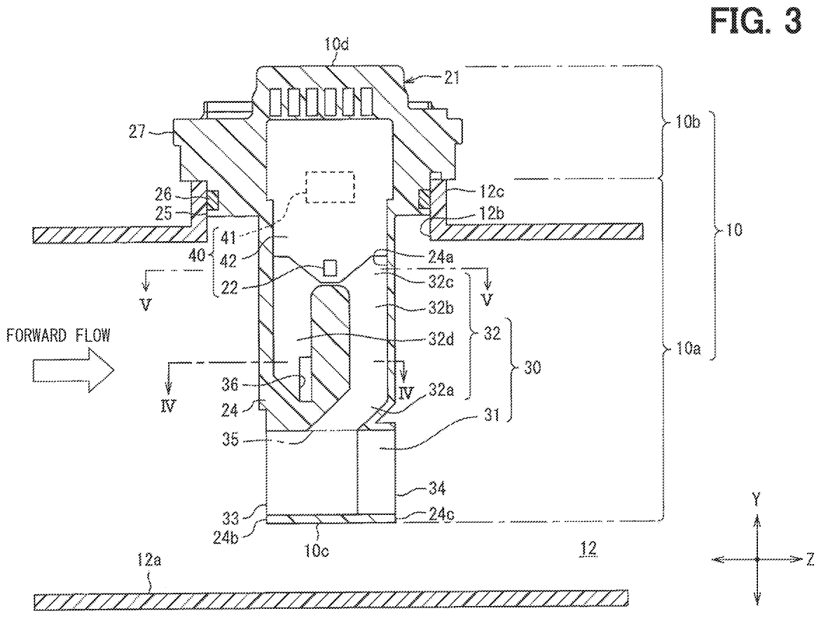

An air flow meter 10 as a measurement control device illustrated in FIGS. 1 and 2 is included in a combustion system having an internal combustion engine such as a gasoline engine. This combustion system is installed in a vehicle. As illustrated in FIG. 3, the air flow meter 10 is provided in an intake passage 12 for supplying intake air to an internal combustion engine in the combustion system, and physical quantities such as a flow rate, temperature, humidity, and pressure of a fluid including gas such as intake air flowing through the intake passage 12 are measured. In this case, the air flow meter 10 corresponds to a flow rate measurement device.

The air flow meter 10 is attached to an intake pipe 12a such as an intake duct forming the intake passage 12. The intake pipe 12a has an air flow insertion hole 12b as a through hole penetrating an outer peripheral portion thereof. An annular pipe flange 12c is attached to the air flow insertion hole 12b, and this pipe flange 12c is included in the intake pipe 12a. The air flow meter 10 is inserted into the pipe flange 12c and the air flow insertion hole 12b and has thereby entered the intake passage 12, and is fixed to the intake pipe 12a and the pipe flange 12c in this state.

In the present embodiment, a width direction X, a height direction Y, and a depth direction Z of the air flow meter 10 are orthogonal to each other. The air flow meter 10 extends in the height direction Y, and the intake passage 12 extends in the depth direction Z. The air flow meter 10 has an entering portion 10a that has entered the intake passage 12 and a protruding portion 10b that protrudes from the pipe flange 12c without entering the intake passage 12, and the entering portion 10a and the protruding portion 10b are aligned in the height direction Y. The air flow meter 10 has end surfaces 10c and 10d in which one included in the entering portion 10a will be referred to as an air flow distal end surface 10c, and the other included in the protruding portion 10b will be referred to as an air flow base end surface 10d. In this case, the air flow distal end surface 10c and the air flow base end surface 10d are aligned in the height direction Y. The air flow distal end surface 10c and the air flow base end surface 10d are orthogonal to the height direction Y. The distal end surface of the pipe flange 12c is also orthogonal to the height direction Y.

As illustrated in FIGS. 1 to 3, the air flow meter 10 has a housing 21 and a sensing unit 22 for detecting a flow rate of intake air. The sensing unit 22 is provided in an internal space 24a of a housing body 24. The housing 21 is formed by, for example, a resin material or the like. By attaching the housing 21 of the air flow meter 10 to the intake pipe 12a, the sensing unit 22 is in a state where it can come into contact with the intake air flowing through the intake passage 12. The housing 21 has a housing body 24, a ring holding portion 25, a flange portion 27, and a connector portion 28. As illustrated in FIG. 3, an O-ring 26 is attached to the ring holding portion 25.

As illustrated in FIGS. 1 to 3, the housing body 24 has an appearance formed in a columnar shape extending in the height direction Y as a whole. The housing 21 is in a state where the ring holding portion 25, the flange portion 27, and the connector portion 28 are integrally provided with the housing body 24. The ring holding portion 25 is included in the entering portion 10a, and the flange portion 27 and the connector portion 28 are included in the protruding portion 10b.

The ring holding portion 25 is provided inside the pipe flange 12c and holds the O-ring 26 so that the O-ring is not displaced in the height direction Y. The O-ring 26 is a sealing member that seals the intake passage 12 inside the pipe flange 12c, and is in close contact with both an outer peripheral surface of the ring holding portion 25 and an inner peripheral surface of the pipe flange 12c. The flange portion 27 is formed with a fixing hole such as a screw hole for fixing a fixture such as a screw for fixing the air flow meter 10 to the intake pipe 12a. The connector portion 28 is a protective unit that protects a connector terminal electrically connected to the sensing unit 22.

As illustrated in FIG. 3, the housing body 24 forms a bypass passage 30 through which a part of the intake air flowing through the intake passage 12 flows. The bypass passage 30 is arranged in the entering portion 10a of the air flow meter 10. The bypass passage 30 has a passage path 31 and a measurement path 32, and the passage path 31 and the measurement path 32 are formed by the internal space 24a of the housing body 24. The intake passage 12 can also be referred to as a main passage, and the bypass passage 30 can also be referred to as a sub passage.

The passage path 31 penetrates the housing body 24 in the depth direction Z. The passage path 31 has an inflow port 33 that is an upstream end thereof and an outflow port 34 that is a downstream end thereof. The inflow port 33 and the outflow port 34 are arranged in the depth direction Z, and the depth direction Z corresponds to an arrangement direction. The measurement path 32 is a branch passage branched from an intermediate portion of the passage path 31, and the sensing unit 22 is provided in the measurement path 32. The measurement path 32 has a measurement inlet 35 that is an upstream end thereof and a measurement outlet 36 that is a downstream end thereof. The portion where the measurement path 32 branches from the passage path 31 is a boundary portion between the passage path 31 and the measurement path 32, and the measurement inlet 35 is included in this boundary portion.

The sensing unit 22 has a circuit board and a detection element mounted on the circuit board, and is a chip-type flow sensor. The detection element has a heater unit such as a heat generation resistor and a temperature detection unit that detects a temperature of air heated by the heater unit. The sensing unit 22 outputs an output signal from the temperature detection unit according to a change in temperature due to heat generation of the heater unit in the detection element. The sensing unit 22 can also be referred to as a flow rate detecting unit.

The air flow meter 10 has a sensor sub-assembly including the sensing unit 22, and this sensor sub-assembly will be referred to as a sensor SA 40. The sensor SA 40 is housed in the housing body 24. In addition to the sensing unit 22, the sensor SA 40 has a circuit chip 41 electrically connected to the sensing unit 22, and a mold unit 42 that protects the sensing unit 22 and the circuit chip 41. The circuit chip 41 has a digital circuit that performs various processes, and is a rectangular parallelepiped chip component. In the sensor SA 40, the sensing unit 22 and the circuit chip 41 are supported by a lead frame, and the circuit chip 41 is electrically connected to the sensing unit 22 and the lead frame via a bonding wire or the like.

The mold unit 42 is a mold resin such as a polymer resin molded by molding, and has higher insulating properties than the lead frame and the bonding wire. The mold unit 42 protects the circuit chip 41 and the sensing unit 22 in a state where the circuit chip 41, the bonding wire, and the like are sealed. In the sensor SA 40, the sensing unit 22 and the circuit chip 41 are mounted in one package by the mold unit 42. The sensor SA 40 can also be referred to as a detection unit or a sensor unit.

The sensing unit 22 outputs an output signal according to the air flow rate in the measurement path 32 to the circuit chip 41, and the circuit chip 41 calculates the flow rate using the output signal of the sensing unit 22. The calculation result of the circuit chip 41 is the flow rate of air measured by the air flow meter 10. The inflow port 33 and the outflow port 34 of the air flow meter 10 are arranged at a center position of the intake passage 12 in the height direction Y. The intake air flowing through the central position of the intake passage 12 in the height direction Y flows along the depth direction Z. The direction in which the intake air flows in the intake passage 12 and the direction in which the intake air flows in the passage path 31 are substantially the same. The sensing unit 22 is not limited to a thermal type flow sensor, and may be an ultrasonic type flow sensor, a Karman vortex type flow sensor, or the like.

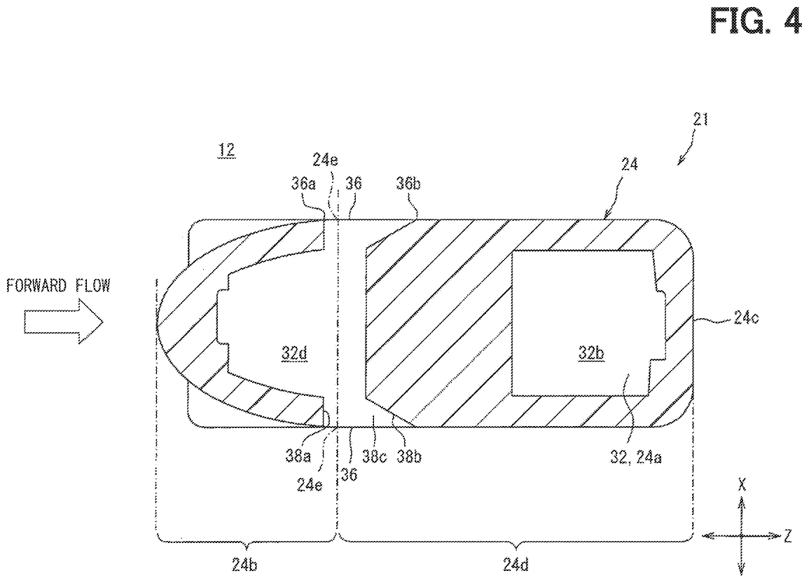

As illustrated in FIG. 4, an outer peripheral surface of the housing body 24 included in the housing 21 has an upstream outer surface 24b, a downstream outer surface 24c, and an intermediate outer surface 24d. On the outer peripheral surface of the housing body 24, the upstream outer surface 24b faces an upstream side of the intake passage 12, and the downstream outer surface 24c faces a downstream side of the intake passage 12. The pair of intermediate outer surfaces 24d face opposite sides to each other in the width direction X and are flat surfaces extending in the depth direction Z. The upstream outer surface 24b is an inclined surface inclined with respect to the intermediate outer surfaces 24d. In this case, the upstream outer surface 24b is an inclined surface curved so as to gradually reduce a width dimension of the housing body 24 toward the upstream side in the intake passage 12 in the width direction X.

The intermediate outer surface 24d is provided between the upstream outer surface 24b and the downstream outer surface 24c in the depth direction Z. In this case, the upstream outer surface 24b and the intermediate outer surface 24d are arranged in the depth direction Z, and a surface boundary portion 24e, which is a boundary between the upstream outer surface 24b and the intermediate outer surface 24d, extends in the height direction Y. The upstream outer surface 24b and the downstream outer surface 24c are end surfaces facing opposite to each other in the depth direction Z.

As illustrated in FIG. 3, the inflow port 33 is provided on the upstream outer surface 24b, and the outflow port 34 is provided on the downstream outer surface 24c. In this case, the inflow port 33 and the outflow port 34 are open in opposite directions. As illustrated in FIG. 4, the measurement outlet 36 is provided on both the upstream outer surface 24b and the intermediate outer surface 24d by arranging the measurement outlet 36 at a position over the surface boundary portion 24e in the depth direction Z. In the measurement outlet 36, a portion arranged on the upstream outer surface 24b is open to face a direction inclined toward the inflow port 33 with respect to the width direction X, and a portion arranged on the intermediate outer surface 24d is open in the width direction X. In this case, the measurement outlet 36 is not open toward the outflow port 34. That is, the measurement outlet 36 is not open toward the downstream side in the intake passage 12.

The measurement outlet 36 has a vertically long flat shape extending along the surface boundary portion 24e. The measurement outlet 36 is arranged at a position closer to the intermediate outer surface 24d with reference to the surface boundary portion 24e in the depth direction Z. In the measurement outlet 36, the area of a portion arranged on the intermediate outer surface 24d is larger than the area of a portion arranged on the upstream outer surface 24b. In this case, in the depth direction Z, a separation distance between a downstream end 36b of the measurement outlet 36 and the surface boundary portion 24e is larger than a separation distance between an upstream end 36a of the measurement outlet 36 and the surface boundary portion 24e.

An inner peripheral surface of the measurement path 32 has formation surfaces 38a to 38c forming the measurement outlet 36. A through hole forming the measurement outlet 36 is provided in an outer peripheral portion of the housing body 24, and the formation surfaces 38a to 38c are included in an inner peripheral surface of the through hole. Among the formation surfaces 38a to 38c, the upstream formation surface 38a forms the upstream end 36a of the measurement outlet 36, and the downstream formation surface 38b forms the downstream end 36b of the measurement outlet 36. The connection formation surfaces 38c connect the upstream formation surface 38a and the downstream formation surface 38b, and provided in a pair sandwiching the formation surfaces 38a and 38b.

The upstream formation surface 38a is orthogonal to the depth direction Z and extends in the width direction X from the upstream end 36a of the measurement outlet 36 toward the inside of the housing body 24. The downstream formation surface 38b is inclined with respect to the depth direction Z, and is an inclined surface extending straight from the downstream end 36b of the measurement outlet 36 into the housing body 24 toward the upstream outer surface 24b.

The flow of intake air generated on an outer peripheral side of the housing body 24 in the intake passage 12 will be briefly described. In air flowing toward the downstream side of the intake passage 12, air that has reached the upstream outer surface 24b of the housing body 24 travels along the upstream outer surface 24b, which is an inclined surface, to thereby gradually change in its direction to reach the measurement outlet 36. In this manner, the direction of the air is smoothly changed by the upstream outer surface 24b, and thus it is difficult for the air to separate in the vicinity of the measurement outlet 36. Thus, it is easy for the air flowing through the measurement path 32 to flow out from the measurement outlet 36, and a flow velocity in the measurement path 32 tends to be stable.

The air flowing through the measurement path 32 and flowing out from the measurement outlet 36 to the intake passage 12 flows along the downstream formation surface 38b, which is an inclined surface, so that the air easily flows toward the downstream side in the intake passage 12. In this case, when the air flowing out from the measurement outlet 36 along the downstream formation surface 38b joins the intake air flowing through the intake passage 12, turbulence such as a vortex is less likely to occur, so that the flow velocity of the inside of the measurement path 32 tends to be stable.

As illustrated in FIG. 3, the measurement path 32 has a folded shape that is folded back between the measurement inlet 35 and the measurement outlet 36. The measurement path 32 includes a branch path 32a branched from the passage path 31, a guide path 32b that guides air flowing from the branch path 32a toward the sensing unit 22, a detection path 32c provided with the sensing unit 22, and a discharge path 32d that discharges air from the measurement outlet 36. In the measurement path 32, the branch path 32a, the guide path 32b, the detection path 32c, and the discharge path 32d are arranged in this order from the upstream side.

The detection path 32c is in parallel to the passage path 31 by extending in the depth direction Z, and is provided at a position separated from the passage path 31 toward the protruding portion 10b. The branch path 32a, the guide path 32b, and the discharge path 32d are provided between the detection path 32c and the passage path 31. The guide path 32b and the discharge path 32d are parallel to each other because they extend in the height direction Y from the detection path 32c toward the passage path 31. The branch path 32a extends from the measurement inlet 35 toward the detection path 32c and the downstream outer surface 24c so as to be inclined with respect to the depth direction Z, and is a straight flow path. The discharge path 32d is provided between the inflow port 33 and the guide path 32b in the depth direction Z, and extends from the measurement outlet 36 toward the detection path 32c.

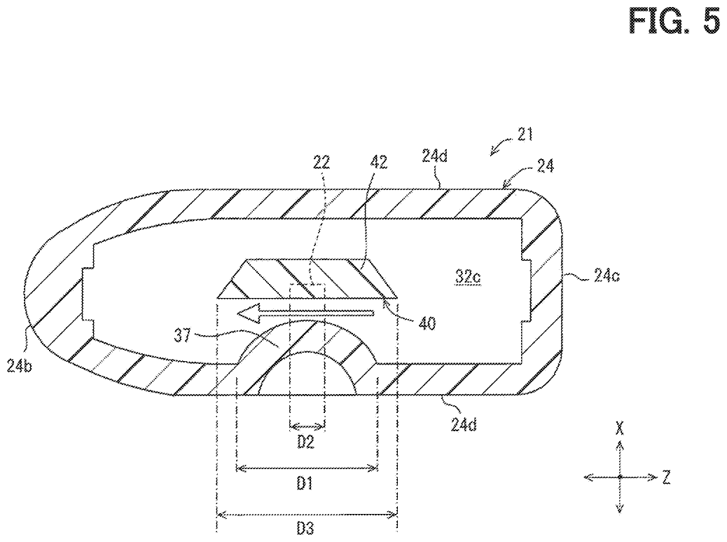

As illustrated in FIG. 5, the sensor SA 40 is arranged at a position where the sensing unit 22 has entered the detection path 32c. The sensing unit 22 is arranged between the pair of intermediate outer surfaces 24d in the width direction X, and extends in the depth direction Z and the height direction Y. The sensing unit 22 is in a state of partitioning the detection path 32c in the width direction X.

The housing 21 has a detection narrow portion 37 that gradually narrows the detection path 32c toward the sensing unit 22 in the depth direction Z. The detection narrow portion 37 gradually reduces a cross-sectional area of the detection path 32c from the downstream outer surface 24c toward the sensing unit 22 in the detection path 32c. The detection narrow portion 37 gradually reduces the cross-sectional area of the detection path 32c from the upstream outer surface 24b toward the sensing unit 22 in the detection path 32c. In the detection path 32c, the cross-sectional area is defined as a cross-sectional area in a direction orthogonal to the depth direction Z. When air is flowing in the forward direction toward the sensing unit 22 in the detection path 32c, the detection narrow portion 37 can adjust the direction of air flow by gradually reducing the detection path 32c.

The detection narrow portion 37 is provided at a position facing the sensing unit 22 on an inner peripheral surface of the detection path 32c. The detection narrow portion 37 protrudes from an inner peripheral surface of the housing body 24 toward the sensing unit 22, and a depth dimension D1 of the detection narrow portion 37 in the depth direction Z is larger than a depth dimension D2 of the sensing unit 22 in the depth direction Z. In a region where the sensing unit 22 exists in the height direction Y, a depth dimension D3 of the mold unit 42 in the depth direction Z is larger than the depth dimension D1 of the detection narrow portion 37.

The detection narrow portion 37 has a tapered shape in the width direction X. Specifically, a base end portion of the detection narrow portion 37 protruding in the width direction X from an inner wall of the housing body 24 is the widest portion, and a distal end portion thereof is the narrowest portion. A width dimension of the base end portion of the detection narrow portion 37 is defined as the above-mentioned depth dimension D1. The detection narrow portion 37 has a curved surface that bulges toward the sensing unit 22. The detection narrow portion 37 may have a tapered shape that bulges toward the sensing unit 22.

In the inner peripheral surface of the detection path 32c, when a surface on the air flow distal end surface 10c side is referred to as a bottom surface, and a surface on the air flow base end surface 10d side is referred to as a ceiling surface, the bottom surface of the detection path 32c is formed by the housing body 24, and meanwhile the ceiling surface is formed by the sensor SA 40. The detection narrow portion 37 extends from the bottom surface of the detection path 32c toward the ceiling surface. An outer peripheral surface of the detection narrow portion 37 extends straight in the height direction Y.

The detection path 32c has a configuration in which a separation distance between the mold unit 42 and the detection narrow portion 37 gradually decreases while approaching the sensing unit 22 in the depth direction Z. In this configuration, when the intake air flowing from the guide path 32b to the detection path 32c passes between the mold unit 42 and the detection narrow portion 37, the flow velocity of the intake air tends to increase as the air approaches the sensing unit 22. In this case, since the intake air is given to the sensing unit 22 at an appropriate flow rate, the output of the sensing unit 22 tends to be stable, and detection accuracy can be improved.

In the intake passage 12, when a pulsation such as an intake pulsation occurs in the flow of intake air due to the operating state of the engine or the like, in addition to a forward flow from the upstream side, a backflow that flows in an opposite direction of the forward flow may occur from the downstream side accompanying this pulsation. In the intake passage 12, the inflow port 33 of the passage path 31 is open toward the upstream side of the intake passage 12, and the forward flow can easily flow into the inflow port 33. The outflow port 34 of the passage path 31 is open toward the downstream side of the intake passage 12, and the backflow easily flows into the outflow port 34. Moreover, in the intake passage 12, the measurement outlet 36 of the measurement path 32 is not open toward the downstream side of the intake passage 12, and the backflow is less likely to flow into the measurement outlet 36.

Unlike the present embodiment, for example, in a configuration in which a part of the outer peripheral surface is a stepped surface facing the downstream side in the housing body 24, and the measurement outlet 36 is formed on this stepped surface, it is conceivable that turbulence such as vortex is likely to occur in the air passing through the stepped surface in the intake passage 12. On the other hand, in the present embodiment, since the measurement outlet 36 is not formed on the stepped surface, the turbulence of the air flow is less likely to occur around the measurement outlet 36, and a case where easiness of the backflow to enter the measurement outlet 36 fluctuates is less likely to occur. As described above, since unstable backflow is unlikely to occur in the measurement path 32, stable pulsation measurement can be achieved in the air flow meter 10.

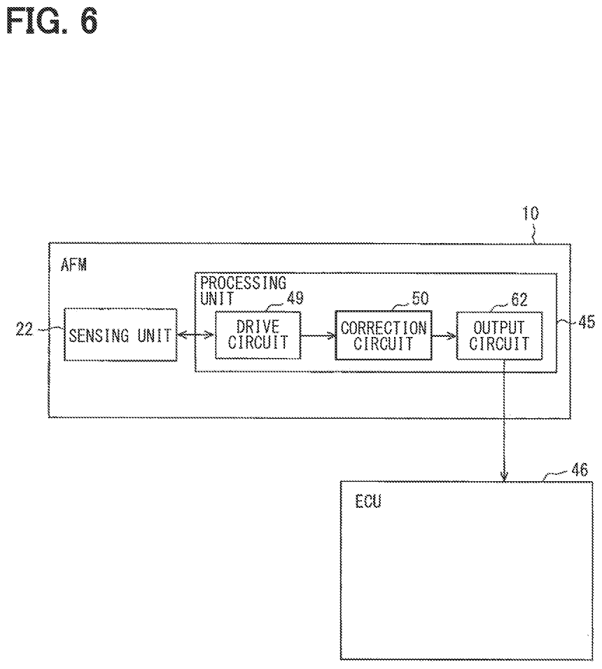

As illustrated in FIG. 6, the air flow meter 10 has a processing unit 45 that processes an output signal of the sensing unit 22. The processing unit 45 is provided on the circuit chip 41 and is electrically connected to the ECU (Electronic Control Unit) 46. The ECU 46 is an engine control device having a function of controlling the engine on the basis of a measurement signal from the air flow meter 10, and the like. The measurement signal from the air flow meter 10 is an electric signal indicating the air flow rate corrected by a pulsation error correction unit 61 described later. One-way communication is possible between the processing unit 45 and the ECU 46, and while the processing unit 45 inputs a signal to the ECU 46, the ECU 46 does not input a signal to the processing unit 45. The ECU 46 is provided independently of the processing unit 45 and the air flow meter 10, and corresponds to an external device.

The ECU 46 is electrically connected to an engine sensor such as a crank angle sensor and a cam angle sensor. The ECU 46 acquires engine parameters such as a rotation angle, a rotation speed, and rotation number of the engine using the detection signal of the engine sensor, and controls the engine using these engine parameters. The pulsation generated in the intake air in the intake passage 12 correlates with the engine parameters. However, the ECU 46 of the present embodiment does not output the engine parameters to the processing unit 45, and the processing unit 45 does not use the engine parameter when performing processing such as correction for the output signal of the sensing unit 22.

The sensing unit 22 outputs an output signal corresponding to the air flow rate flowing through the measurement path 32 to the processing unit 45. This output signal is an electric signal, a sensor signal, and a detection signal output from the sensing unit 22, and the output value corresponding to the value of the air flow rate is included in this output signal. The sensing unit 22 can detect the air flow rate for both the air flowing forward in the measurement path 32 from the measurement inlet 35 to the measurement outlet 36 and the air flowing in the reverse direction from the measurement outlet 36 toward the measurement inlet 35. The output value of the sensing unit 22 becomes a positive value when the air is flowing in the forward direction in the measurement path 32, and becomes a negative value when the air is flowing in the reverse direction therein.

When a pulsation occurs in the air flow in the intake passage 12, the sensing unit 22 is affected by the pulsation, and an error with respect to a true air flow rate occurs in the output value. In particular, in the sensing unit 22, when the throttle valve is operated to the fully open side, a pulsation amplitude and a pulsation rate tend to increase. In the following, this error by pulsation is also referred to as a pulsation error Err. The true air flow rate is an air flow rate that is not affected by pulsation. The pulsation rate is a value obtained by dividing the pulsation amplitude by an average value.

The processing unit 45 detects an air flow rate on the basis of an output value of the sensing unit 22, and outputs the detected air flow rate to the ECU 46. The processing unit 45 has a drive circuit 49 that drives the heater unit of the sensing unit 22, a correction circuit 50 that corrects the output value of the sensing unit 22, and an output circuit 62 that outputs a correction result of the correction circuit 50 to the ECU 46. The drive circuit 49 supplies electric power used for driving the heater unit and the like to the sensing unit 22, in addition to drive control of the heater unit. The drive circuit 49 performs preprocessing such as amplifying an output signal of the sensing unit 22 at a stage before the correction circuit 50 performs a correction process.

The processing unit 45 has an arithmetic processing device such as a CPU and a storage device for storing programs and data. For example, the processing unit 45 is achieved by a microcomputer having a storage device that can be read by a computer. The processing unit 45 calculates an air flow rate by performing various calculations by executing a program stored in the storage device by the arithmetic processing device, and outputs the calculated air flow rate to the ECU 46.

A storage device is a non-transitional tangible storage medium that stores computer-readable programs and data non-temporarily. The storage medium is achieved by a semiconductor memory or the like. This storage device can also be rephrased as a storage medium. The processing unit 45 may include a volatile memory for temporarily storing data.

The processing unit 45 has a function of correcting an output value in which the pulsation error Err has occurred. In other words, the processing unit 45 corrects the air flow rate of the output signal so as to approach the true air flow rate. Therefore, the processing unit 45 outputs the air flow rate corrected for the pulsation error Err to the ECU 46 as a measurement signal. The measurement signal includes a measurement value that is a correction result of the output value.

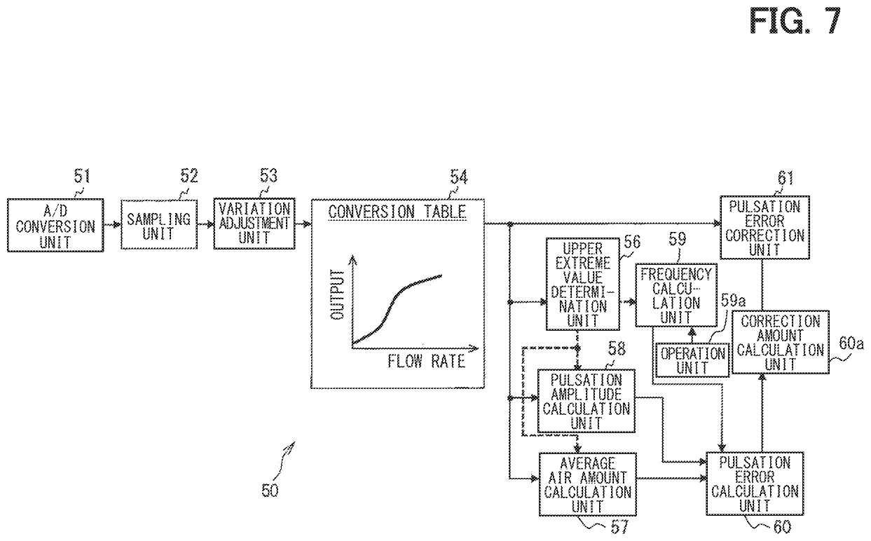

The processing unit 45 operates as a plurality of functional blocks by executing a program. The drive circuit 49, the correction circuit 50, and the output circuit 62 are all functional blocks. As illustrated in FIG. 7, the correction circuit 50 has an A/D conversion unit 51, a sampling unit 52, a variation adjustment unit 53, a conversion table 54, and the like as functional blocks.

The A/D conversion unit 51 A/D-converts an output value input from the sensing unit 22 to the correction circuit 50 via the drive circuit 49. The sampling unit 52 samples the A/D-converted output value at a predetermined sampling interval Δt, and acquires a sampling value at every timing. These sampling values are included in the output value. The variation adjustment unit 53 adjusts variations of the output value of the sensing unit 22 so that measurement values do not vary due to individual differences of the air flow meter 10, such as an individual difference of the sensing unit 22. Specifically, the variation adjustment unit 53 reduces individual variations in a flow rate output characteristic indicating the relationship between the output value and the actual air flow rate and a temperature characteristic indicating the relationship between the flow rate output characteristic and the temperature.

The conversion table 54 converts the sampling value acquired by the sampling unit 52 into an air flow rate. In the present embodiment, the value converted in the conversion table 54 may be referred to as a sampling value or an output value instead of an air flow rate. The conversion table 54 is a conversion table that uses the flow rate output characteristic.

Further, in addition to the components described above as functional blocks, the correction circuit 50 includes an upper extreme value determination unit 56, an average air amount calculation unit 57, a pulsation amplitude calculation unit 58, a frequency calculation unit 59, a pulsation error calculation unit 60, a correction amount calculation unit 60a, and a pulsation error correction unit 61.

The upper extreme value determination unit 56 determines whether or not the sampling value converted in the conversion table 54 is an upper extreme value Ea. The upper extreme value Ea is a sampling value at a timing when the output value switches from increase to decrease. The upper extreme value determination unit 56 acquires a timing when the sampling value has become the upper extreme value Ea as an upper extreme timing ta, and causes the timing to be stored in the storage device of the processing unit 45. The upper extreme value determination unit 56 outputs information including the upper extreme timing ta as timing information indicating a pulsation cycle to the average air amount calculation unit 57, the pulsation amplitude calculation unit 58, and the frequency calculation unit 59. In FIG. 7, an output of information related to the output value of the sensing unit 22 is illustrated by a solid line, and an output of the timing information is illustrated by a broken line.

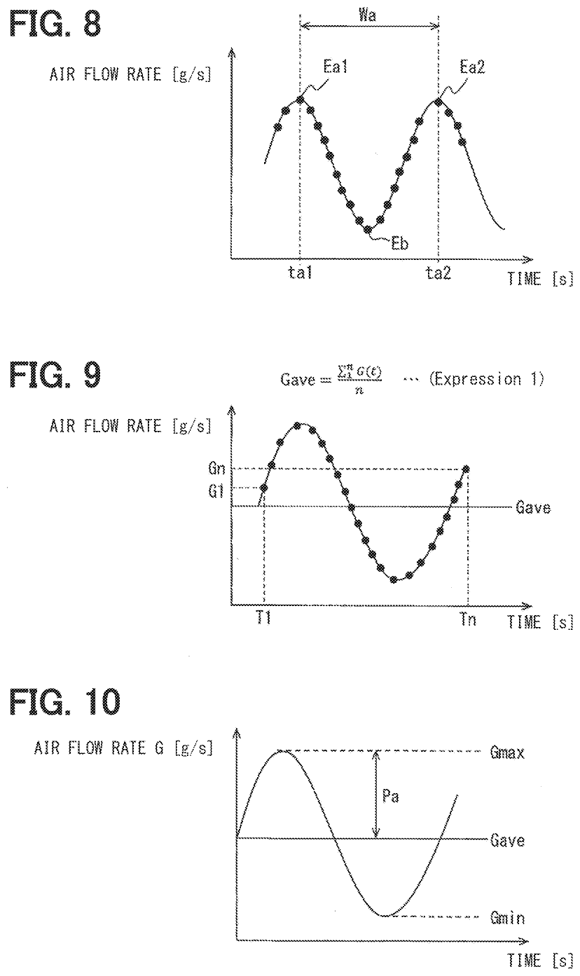

The frequency calculation unit 59 uses the timing information from the upper extreme value determination unit 56 to calculate the interval at which the sampling value becomes the upper extreme value Ea as an upper extreme interval Wa, and uses this upper extreme interval Wa to calculate the pulsation frequency F. For example, as illustrated in FIG. 8, for a case where the sampling value becomes the upper extreme value Ea and then the sampling value becomes the next extreme value Ea, the previous extreme value Ea will be referred to as a first extreme value Ea1, the next extreme value Ea will be referred to as a second extreme value Ea2. In this case, the frequency calculation unit 59 uses a first upper extreme timing ta1 at which the sampling value becomes the first upper extreme value Ea1 and a second upper extreme timing ta2 at which the sampling value becomes the second upper extreme value Ea2, and calculates the upper extreme interval Wa, which is an interval between the upper extreme timing ta1 and ta2. For example, the pulsation frequency F is calculated using the relationship F [Hz]=1/Wa[s]. The upper extreme interval Wa corresponds to the time interval.

For the period from the first upper extreme timing ta1 to the second upper extreme timing ta2, a maximum pulsation value Gmax, which is a maximum value of the air flow rate when the air is pulsating, is the larger one of the first upper extreme value Ea1 and the second upper extreme values Ea2. When these upper extreme values Ea1 and Ea2 are the same value, that value becomes the maximum pulsation value Gmax. The average value of the first upper extreme value Ea1 and the second upper extreme value Ea2 may be the maximum pulsation value Gmax.

Between the first upper extreme value Ea1 and the second upper extreme value Ea2, there is a lower extreme value Eb, which is a sampling value at a timing when the output value switches from decrease to increase. There is only one lower extreme value Eb between the first upper extreme timing ta1 and the second upper extreme timing ta2, and thus this lower extreme value Eb becomes a minimum pulsation value Gmin. FIG. 10 illustrates the maximum pulsation value Gmax, the minimum pulsation value Gmin, and an average air amount Gave with respect to the air flow rate.

The frequency calculation unit 59 has a frequency limiting function that limits a change amount in the pulsation frequency F to be equal to or less than a predetermined maximum frequency change amount.

The frequency calculation unit 59 has an operation unit 59a. The operation unit 59a is for setting whether to enable or disable a frequency limiting function of the frequency calculation unit 59. The operation unit 59a is formed by an on-off switch. The operation unit 59a outputs a signal according to the user's operation to the frequency calculation unit 59.

The frequency calculation unit 59 switches enabling or disabling of the frequency limiting function according to the signal input from the operation unit 59a.

The average air amount calculation unit 57 calculates an average air amount Gave, which is the average value of the air flow rate, by using sampling values converted by the conversion table 54 and the timing information from the upper extreme value determination unit 56. The average air amount calculation unit 57 sets a target period for calculating the average air amount Gave as a measurement period using a determination result of the upper extreme value determination unit 56, and calculates the average air amount Gave for this measurement period. For example, in FIG. 8, when the period from the first upper extreme timing ta1 to the second upper extreme timing ta2 is set as the measurement period, the average air amount Gave is calculated for this measurement period.

The average air amount calculation unit 57 calculates the average air amount Gave using, for example, an integrated average. Here, as an example, calculation of the average air amount Gave using the waveform illustrated in FIG. 9 will be described. In this example, the measurement period is from timing t1 to timing tn, an air flow rate at timing t1 is G1, and an air flow rate at timing tn is Gn. The average air amount calculation unit 57 calculates the average air amount Gave by using Expression 1 described in FIG. 9. In this case, it is possible to calculate the average air amount Gave in which the influence of the minimum pulsation value Gmin, which has relatively low detection accuracy, is reduced when the number of samplings is large rather than when the number of samplings is small.

In the measurement path 32, if the actual air flow rate is sufficiently large, a streamline is less likely to fluctuate when air travels toward the measurement outlet 36, and it is conceivable that the traveling direction and flow rate of the air passing through the sensing unit 22 tend to be stable. Thus, detection accuracy of the sensing unit 22 tends to be high because the actual air flow rate is sufficiently large. On the other hand, as the actual air flow rate decreases, the traveling direction and flow rate of the air tends to be unstable. For example, when the actual air flow rate in the measurement path 32 is the smallest in the range in which no backflow occurs, it is conceivable that the traveling direction and flow rate of the air are not stable because the air meanders while traveling toward the measurement outlet 36, or the like. Therefore, as the actual air flow rate decreases, the detection accuracy of the sensing unit 22 tends to decrease. Therefore, the detection accuracy of the sensing unit 22 is relatively low for the minimum pulsation value Gmin among the output values.

The pulsation amplitude calculation unit 58 calculates a pulsation amplitude Pa, which is the magnitude of the pulsation generated by the air flow rate, using the sampling value converted by the conversion table 54 and the timing information from the upper extreme value determination unit 56. The pulsation amplitude calculation unit 58 targets the measurement period for calculation, and as illustrated in FIG. 10, calculates the pulsation amplitude Pa of the air flow rate by taking a difference between the maximum pulsation value Gmax and the average air amount Gave. That is, the pulsation amplitude calculation unit 58 obtains a half amplitude of the air flow rate instead of the total amplitude of the air flow rate. This is to reduce the influence of the minimum pulsation value Gmin, which has relatively low detection accuracy as described above. The pulsation amplitude calculation unit 58 may calculate the total amplitude, which is a difference between the maximum pulsation value Gmax and the minimum pulsation value, as the pulsation amplitude.

Regarding the output value of the sensing unit 22, the upper extreme value Ea, the pulsation frequency F, the pulsation amplitude Pa, and the average air amount Gave indicate a pulsation state that is a state of pulsation, and correspond to the pulsation parameters. In this case, the upper extreme value determination unit 56, the average air amount calculation unit 57, the pulsation amplitude calculation unit 58, and the frequency calculation unit 59 correspond to a pulsation state calculation unit for calculating the pulsation state.

The pulsation error calculation unit 60 calculates the pulsation error Err correlated with the pulsation amplitude Pa for the air flow rate. The pulsation error calculation unit 60 predicts the pulsation error Err of the air flow rate by using, for example, a map in which the pulsation amplitude Pa and the pulsation error Err are associated with each other, or the like. That is, when the pulsation amplitude calculation unit 58 obtains the pulsation amplitude Pa, the pulsation error calculation unit 60 extracts the pulsation error Err that correlates with the obtained pulsation amplitude Pa from the map. It can be said that the pulsation error calculation unit 60 acquires the pulsation error Err that correlates with the pulsation amplitude Pa for the measurement period as a target.

As described above, the air flow meter 10 is attached to the intake pipe 12a forming the intake passage 12. Thus, in the air flow meter 10, due to influence of a shape of the intake pipe 12a, or the like, not only the pulsation error Err increases as the pulsation amplitude Pa increases, but also the pulsation error Err can decrease as the pulsation amplitude Pa increases. Thus, there may be cases where, in the air flow meter 10, the relationship between the pulsation amplitude Pa and the pulsation error Err cannot be expressed by a function. Therefore, the air flow meter 10 is preferable because the accurate pulsation error Err can be predicted by using the map as described above. The map may be associated with a plurality of pulsation amplitudes Pa and a correction amount Q correlated with each pulsation amplitude Pa.

However, there may be cases where, in the air flow meter 10, the relationship between the pulsation amplitude Pa and the pulsation error Err by a function can be expressed in a case where the sensing unit 22 is directly arranged in the main air passage, and the like. In this case, the air flow meter 10 may use this function to calculate the pulsation error Err. The air flow meter 10 does not need to have a map by calculating the pulsation error Err using the function, and thus the capacity of the storage device can be reduced. This point similarly applies to the following embodiments. That is, in the following embodiment, the pulsation error Err may be obtained by using a function instead of the map.

The pulsation error Err is the difference between an uncorrected air flow rate obtained by the output value and the true air flow rate. That is, the pulsation error Err corresponds to the difference between the air flow rate whose output value is converted by the conversion table 54 and the true air flow rate. Thus, the correction amount Q for bringing the air amount before correction close to the true air flow rate can be obtained if the pulsation error Err is known.

As illustrated in FIG. 7, to the pulsation error calculation unit 60, the average air amount Gave calculated by the average air amount calculation unit 57, the pulsation amplitude Pa calculated by the pulsation amplitude calculation unit 58, and the calculated pulsation frequency F calculated by the frequency calculation unit 59 are input. The pulsation error calculation unit 60 calculates the pulsation error Err using the average air amount Gave, the pulsation amplitude Pa, and the pulsation frequency F.

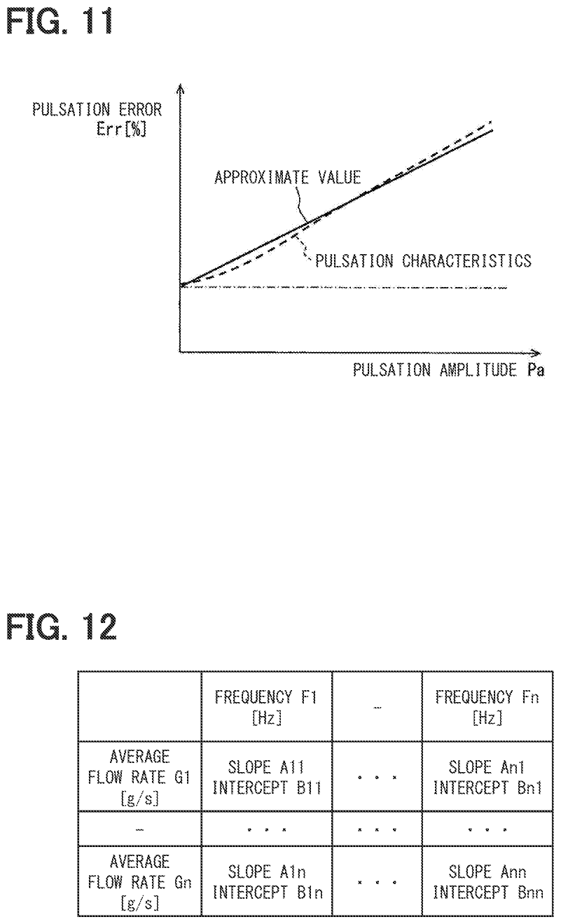

When pulsation occurs in the air flow, as the average air amount Gave increases, the pulsation amplitude Pa tends to increase. When the pulsation amplitude Pa and the pulsation error Err are almost in a proportional relationship in the pulsation characteristics illustrating the relationship between the pulsation amplitude Pa and the pulsation error Err, an approximate line for the pulsation characteristics can be illustrated by a straight line as illustrated in FIG. 11.

Err=Ann×Pa+Bnn (Expression 2)

For the approximate line for pulsation characteristics, the relationship of Expression 2 above holds. This relational expression is an error prediction expression for predicting the pulsation error Err using the pulsation amplitude Pa, and in this error prediction formula, Ann is a slope of the approximate line and Bnn is the intercept. In the pulsation characteristics, the pulsation error Err corresponds to a correction parameter. The approximate line for the pulsation characteristics may be illustrated by a curve. In this case, the expression representing the approximate line for the pulsation characteristics includes a quadratic function or a function of second order or higher such as a cubic function.

The pulsation characteristics are set for each combination of the average air amount Gave and the pulsation frequency F. In the map illustrated in FIG. 12, a slope Ann and an intercept Bnn indicating pulsation characteristics are set for each window illustrating the combination of the average air amount Gave and the pulsation frequency F. When such a map illustrating the relationship between the average air amount Gave and the pulsation frequency F and the pulsation characteristics is referred to as a reference map, this reference map is a two-dimensional map and is stored in the storage device of the processing unit 45. In the reference map, the pulsation characteristics are set for each of the average air amount Gave and the pulsation frequency F with respect to predetermined values defined in advance. The reference map may be a map having three or more dimensions such as a three-dimensional map or a four-dimensional map. For example, a three-dimensional map illustrating the relationship between the average air amount Gave and the pulsation frequency F and the pulsation amplitude Pa may be used as a reference map.

In FIG. 12, map values of the average air amount Gave set in the reference map are denoted by G1 to Gn, and map values of the pulsation frequency F are denoted by F1 to Fn. The reference map may be referred to as a correction map, and the reference information may be referred to as correction information.

The reference map can be created by confirming the relationship between the pulsation amplitude Pa and the pulsation error Err correlated with the pulsation amplitude Pa by experiments, simulations, or the like using an actual machine. That is, it can be said that the pulsation error Err is a value obtained for each pulsation amplitude Pa when an experiment or simulation using an actual machine is performed by changing the value of the pulsation amplitude Pa. The other maps in the following embodiments can also be created by experiments, simulations, or the like using an actual machine, like the reference map.

The correction amount calculation unit 60a calculates the correction amount Q using the pulsation error Err calculated by the pulsation error calculation unit 60. The correction amount calculation unit 60a targets the measurement period for calculation, and calculates the correction amount Q by using the correlation information such as a map illustrating the correlation between the pulsation error Err and the correction amount Q. The correction amount Q is a value indicating the ratio of the correction to the output value. For example, when the output value is corrected so that the air flow rate becomes large, the correction amount Q becomes larger than 1, and when the output value is corrected so that the air flow rate becomes small, the correction amount Q becomes smaller than 1. The correction ratio can also be referred to as a gain.

The pulsation error correction unit 61 corrects the air flow rate so that the pulsation error Err becomes small by using the sampling value converted by the conversion table 54 and the correction amount Q calculated by the correction amount calculation unit 60a. That is, the pulsation error correction unit 61 corrects the air flow rate so that the air flow rate affected by the pulsation approaches the true air flow rate. Here, the average air amount Gave is employed as the correction target of the air flow rate.

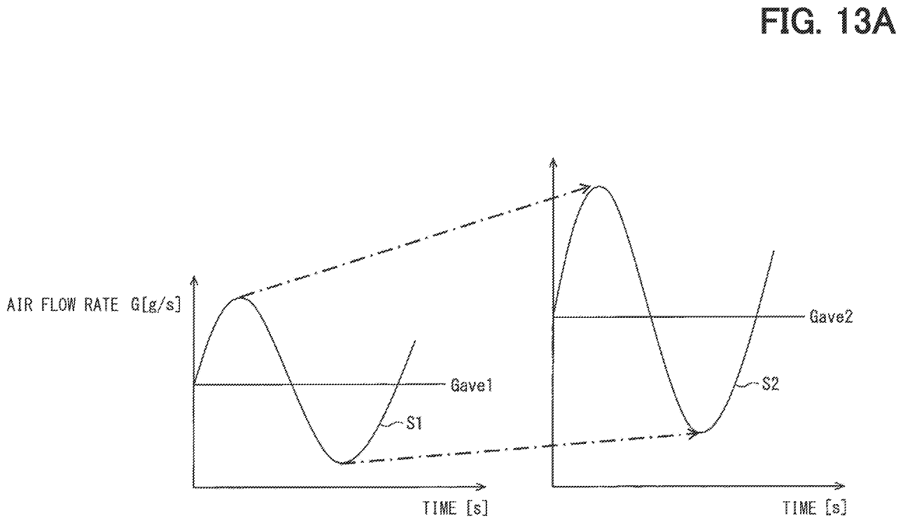

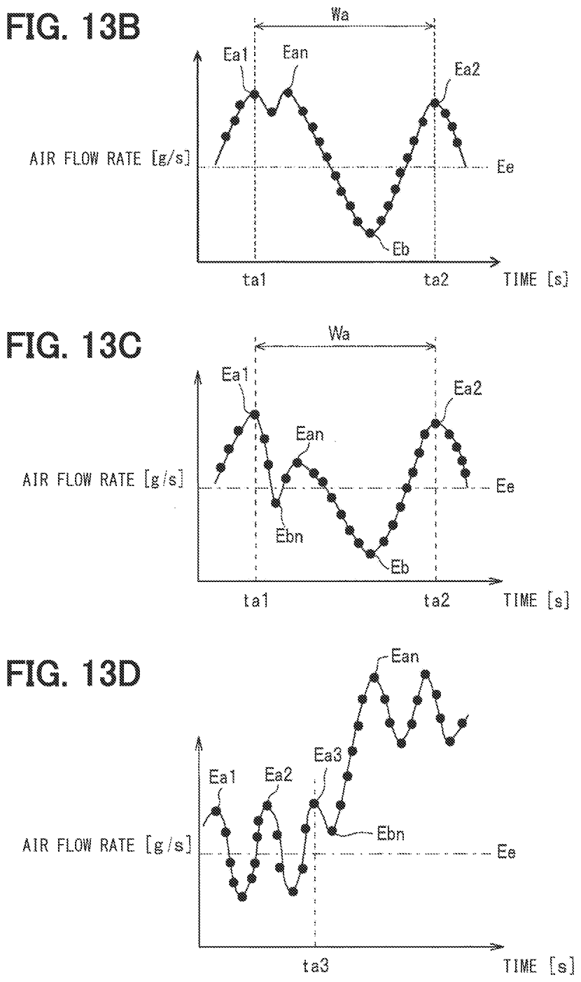

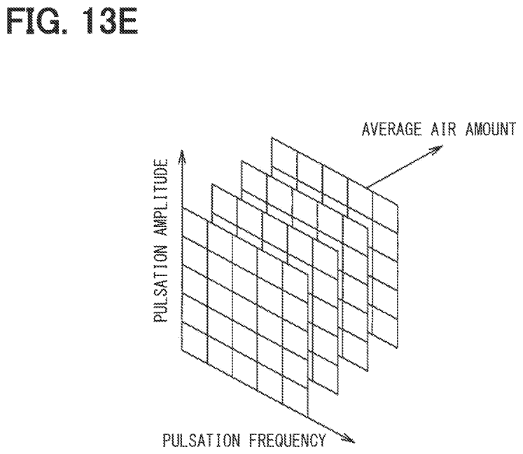

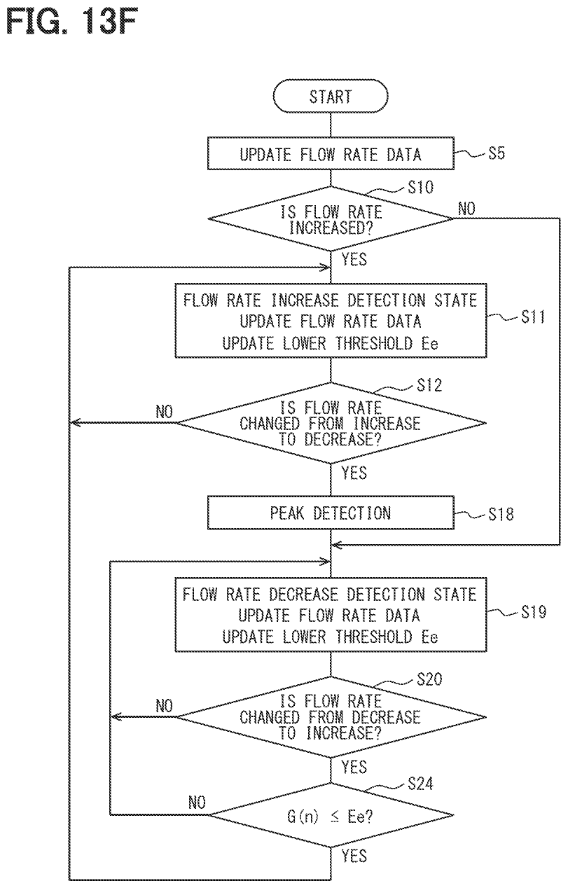

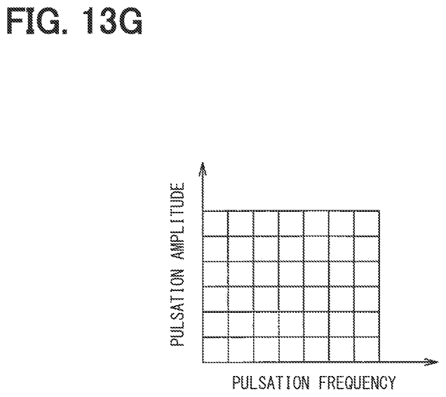

The pulsation error correction unit 61 corrects an output value S1 before correction with the correction amount Q and calculates the output value S2 after correction. In the present embodiment, the output value S2 after correction is calculated by multiplying the output value S1 before correction by the correction amount Q. In this case, the relationship S2=S1×Q holds. For example, when the correction amount Q is larger than 1, the output value S2 after correction becomes larger than the output value S1 before correction, as illustrated in FIG. 13A. The pulsation error correction unit 61 targets the measurement period for calculation, and the output value S1 before correction includes at least the upper extreme value Ea and the lower extreme value Eb.

The correction circuit 50 outputs the output value S2 after correction calculated by the pulsation error correction unit 61 to the output circuit 62. The output circuit 62 outputs the output value S2 after correction to the ECU 46. The ECU 46 uses the output value S2 after correction input from the output circuit 62 to calculate the average value of the output value S2 after correction as the corrected average air amount Gave2. For example, when the correction amount Q is larger than 1, as illustrated in FIG. 13A, the average air amount Gave2 after correction is larger than the average air amount Gave1 before correction.

For example, as illustrated in FIG. 13B, an upper extreme value Ean due to noise may occur in the waveform representing a time change of the output value of the sensing unit 22 or a conversion value of the conversion table 54. This noise is caused by air turbulence, not electrical noise. Specifically, due to switching of each stroke of the combustion cycle, such as switching from an intake stroke to a compression stroke in any cylinder of the internal combustion engine, the flow rate of the intake air flowing through the intake passage 12 becomes unstable at the time of the switching. Thus, the air flow rate measured by the sensing unit 22 also becomes unstable at the time of switching of each stroke of the combustion cycle. Due to such air turbulence, in the waveform illustrated in FIG. 13B, the upper extreme value Ean due to noise appears immediately after the upper extreme value Ea1. That is, a portion that slightly repeats increasing and decreasing appears in the waveform.

The upper extreme value determination unit 56 negatively determines and cancels the upper extreme value Ean due to noise because it is not the upper extreme value used for calculating the upper extreme interval Wa. Specifically, the upper extreme value determination unit 56 determines whether or not the output value has become equal to or less than the lower threshold Ee during a period from the upper extreme timing ta1 when the upper extreme value Ea1 has previously appeared to a timing when the upper extreme value Ean at present time has appeared. Upon determining that the output value remains to be more than the lower threshold Ee, the upper extreme value determination unit 56 regards the upper extreme value Ean at present time as due to noise and cancels the upper extreme value Ean. Therefore, the upper extreme value Ean due to noise is not erroneously detected as the upper extreme value.

However, for example, as illustrated in FIG. 13C, a lower extreme value Ebn due to harmonics may occur in the waveform representing the time change of the output value of the sensing unit 22 or the conversion value of the conversion table 54. That is, due to the influence of harmonics, a valley portion like a crack may appear in the waveform, and the output value may change suddenly.

In this case, the output value has become equal to or less than the lower threshold Ee during the period from the upper extreme timing ta1 when the upper extreme value Ea1 has previously appeared to the timing when the upper extreme value Ean at present time has appeared, the upper extreme value Ean at present time is not canceled and is erroneously detected as an upper extreme value.

For example, as illustrated in FIG. 13D, a steep output change may occur in a waveform representing a time change of the output value of the sensing unit 22 or the conversion value of the conversion table 54. For example, when the vehicle is accelerating, the output value may change suddenly and greatly.

In this case, during the period from the upper extreme timing ta3 when the upper extreme value Ea3 has previously appeared to the timing when the upper extreme value Ean at present time has appeared, the output value becomes higher without becoming equal to or less than the lower threshold Ee. If the output value becomes high without becoming equal to or less than the lower threshold Ee in this manner, there is a problem that the upper extreme value Ean detected from the next time onward will be canceled one after another and will not be detected as the upper extreme value.

In order to solve these issues, the upper extreme value determination unit 56 of the present embodiment carries out a process of updating the lower threshold Ee so that the value of the lower threshold Ee changes.

As illustrated in FIG. 13E, the memory of the present embodiment stores a map in which the pulsation amplitude Pa, the pulsation frequency F, and the average air amount Gave are associated with a reference value of the lower threshold Ee. This map is a three-axis map centered on the three variables of a pulsation amplitude Pa, a pulsation frequency F, and an average air amount Gave.

The upper extreme value determination unit 56 updates the lower threshold Ee with reference to this map. The reference value may be a constant or a function. Specifically, the reference value of the lower threshold Ee corresponding to the pulsation amplitude Pa, the pulsation frequency F, and the average air amount Gave is updated as a new lower threshold Ee.

As the engine speed increases, the pulsation frequency F also increases, and harmonic noise is likely to be included in the output value of the sensing unit 22. Thus, for example, the lower threshold Ee can be set to be a smaller value as the pulsation frequency F is larger. When the accelerator is depressed and the engine speed increases, the average air amount Gave also increases, and the output value of the sensing unit 22 tends to include harmonic noise. Thus, for example, the lower threshold Ee can be set to be a smaller value as the average air amount Gave is larger. When the engine speed reaches a specific speed, the pulsation amplitude Pa may increase. Therefore, for example, the lower threshold Ee can be set to be smaller as the pulsation amplitude Pa is larger. The map stores the reference value of an optimum lower threshold Ee obtained by the experiment.

FIG. 13F is a flowchart illustrating a procedure of processing by the upper extreme value determination unit 56. The process illustrated in FIG. 13F is repeatedly executed by a microcomputer during the period in which the output value is input to the correction circuit 50. The microcomputer processing here means processing in a digital circuit, and can be processed by, for example, a DSP or hard logic. The DSP is an abbreviation for digital signal processor. First, in step S5, the flow rate data is updated. Specifically, new flow rate data is read. In the next step S10, it is determined whether or not the sampling value at present time is increasing in the flow rate in the waveform of the sampling value converted by the conversion table 54.

When it is determined that the value is increasing, the flow rate data and the lower threshold Ee are updated as a flow rate increase detection state in the next step S11. Specifically, the pulsation amplitude Pa, the pulsation frequency F, and the average air amount Gave are specified, the reference value of the lower threshold Ee corresponding to these is specified using the map, and the lower threshold Ee is specified on the basis of the reference value of the lower threshold Ee. This lower threshold Ee is updated as a new lower threshold Ee.

In the next step S12, it is determined whether or not the flow rate has changed from increase to decrease. If it is determined that the flow rate has changed to decrease in step S12, peak detection is performed in next step S18. Specifically, the sampling value at present time is detected as the upper extreme value Ea. If it is not determined that the flow rate has changed to decrease in step S12, the process returns to step 11.

After the processing of step S18, the flow rate data and the lower threshold Ee are updated as a flow rate decrease detection state in step S19. Specifically, the pulsation amplitude Pa, the pulsation frequency F, and the average air amount Gave are specified, the reference value of the lower threshold Ee corresponding to these is specified using the map, and the lower threshold Ee is specified on the basis of the reference value of the lower threshold Ee. This lower threshold Ee is updated as a new lower threshold Ee.

In the next step S20, it is determined whether or not the flow rate has changed from decrease to increase. If it is determined in step S20 that the flow rate has changed to increase, in the next step S24, it is determined whether or not the sampling value at present time is equal to or less than the predetermined lower threshold Ee. If it is not determined in step S20 that the flow rate has changed to increase, or if it is determined in step S24 that the sampling value at present time is not equal to or less than the lower threshold Ee, the process returns to step S19.

If it is determined that the threshold is equal to or less than the lower threshold Ee, the execution is restarted from the processing of step S10. Therefore, when the step S10 is restarted in this manner, the flow rate has just been switched to increase, and thus it is determined that the flow rate is increased in the step S10. In steps S11 and S12, the process waits until the flow rate switches from increase to decrease, and in step S18, the next upper extreme value Ea is detected. Thus, if the output value remains to be more than the predetermined lower threshold Ee after the upper extreme value is detected once, the next upper extreme value is negatively determined.

As described above, the lower threshold Ee is updated in step S11 and step S19. Specifically, the pulsation amplitude Pa, the pulsation frequency F, and the average air amount Gave are specified, and the reference value of the lower threshold Ee corresponding to these is updated as a new lower threshold Ee.

Thus, the lower threshold Ee in FIG. 13C can be made lower than the lower extreme value Ebn due to noise. In this case, the sampling value at present time will be cancelled. Therefore, it is possible to prevent erroneous detection of the lower extreme value Ebn due to noise.

It is also possible to make the lower threshold Ee in FIG. 13D larger than the lower extreme value Ebn. In this case, the upper extreme value Ean will be detected.

Thus, even when a steep output change occurs, the lower threshold Ee can be updated and the upper extreme value Ean can be detected correctly.

As described above, the measurement control device of the present embodiment includes the sensing unit 22 that outputs a signal according to the air flow rate and a pulsation state calculation unit that calculates a pulsation state that is a state of pulsation generated in the air flow rate using the output value of the sensing unit 22. The measurement control device includes a pulsation error correction unit 61 that corrects the air flow rate using the pulsation state calculated by the pulsation state calculation unit. The pulsation state calculation unit has an upper extreme value determination unit 56 that, when the output value when a change mode of the output value switches from increase to decrease is referred to as an upper extreme value Ea, determines whether or not the output value has become the upper extreme value Ea. Moreover, the pulsation state calculation unit has a frequency calculation unit 59 that calculates the pulsation frequency F of pulsation generated in the air flow rate on the basis of the time interval at which the output value becomes the upper extreme value Ea. When the output value remains to be more than the predetermined lower threshold Ee during a period from a timing when the upper extreme value Ea has previously appeared to a timing when the upper extreme value Ea has presently appeared in the waveform representing a time change of the output value, the upper extreme value determination unit 56 negatively determines and cancels the upper extreme value Ea that has presently appeared. Moreover, the upper extreme value determination unit 56 updates the lower threshold Ee on the basis of the air flow rate specified on the basis of the output value, the pulsation frequency F, and the pulsation amplitude Pa specified on the basis of the output value.

With such a configuration, the lower threshold Ee is updated on the basis of the air flow rate specified on the basis of the output value, the pulsation frequency F, and the pulsation amplitude Pa specified on the basis of the output value, and thus false detection of the upper extreme value Ea is reduced. Therefore, the correction accuracy of the air flow rate can be improved.

The upper extreme value determination unit 56 updates the lower threshold Ee using a map in which the air flow rate, the pulsation frequency F, and the pulsation amplitude Pa are associated with the reference value of the lower threshold Ee.

In this manner, the upper extreme value determination unit 56 can update the lower threshold Ee using the map in which the air flow rate, the pulsation frequency F, and the pulsation amplitude Pa and the reference value of the lower threshold Ee are associated with each other.

The measurement control device of the present embodiment includes the sensing unit 22 that outputs a signal according to the air flow rate and a pulsation state calculation unit that calculates a pulsation state that is a state of pulsation generated in the air flow rate using the output value of the sensing unit 22. The measurement control device includes a pulsation error correction unit 61 that corrects the air flow rate using the pulsation state calculated by the pulsation state calculation unit. The pulsation state calculation unit has an upper extreme value determination unit 56 that, when the output value when a change mode of the output value switches from increase to decrease is referred to as an upper extreme value Ea, determines whether or not the output value has become the upper extreme value Ea. The pulsation state calculation unit has the frequency calculation unit 59 that calculates the pulsation frequency F of the pulsation generated in the air flow rate on the basis of a time interval at which the output value becomes the upper extreme value Ea. When the output value remains to be more than the predetermined lower threshold Ee during a period from a timing when the upper extreme value has previously appeared to a timing when the upper extreme value has presently appeared in a waveform representing a time change of the output value, the upper extreme value determination unit 56 negatively determines and cancels the upper extreme value Ea that has presently appeared. Moreover, the upper extreme value determination unit 56 updates the lower threshold Ee on the basis of the reference value of the lower threshold Ee that changes according to the pulsation state.

With such a configuration, the lower threshold Ee is updated on the basis of the reference value of the lower threshold Ee that changes according to the pulsation state, and thus false detection of the upper extreme value Ea is reduced. Therefore, the correction accuracy of the air flow rate can be improved.

The upper extreme value determination unit 56 updates the lower threshold Ee using a map in which the reference value of the lower threshold Ee is associated according to the pulsation state.

In this manner, the lower threshold Ee can be updated using the map in which the reference value of the lower threshold Ee is associated according to the pulsation state.

The frequency calculation unit 59 has a frequency limiting function that limits a change amount in the pulsation frequency F to be equal to or less than a predetermined maximum frequency change amount.

Therefore, for example, even when a high-frequency noise component is added to the output value of the sensing unit 22, the change amount in the pulsation frequency F is limited, so that the influence of noise can be suppressed.

The frequency calculation unit 59 includes an operation unit 59a that sets enable or disable of the frequency limiting function. This makes it possible to enable or disable the frequency limiting function.

In the present embodiment, as illustrated in FIG. 13E, a map in which the pulsation amplitude Pa, the pulsation frequency F, and the average air amount Gave and the reference value of the lower threshold Ee are associated with each other is stored in the memory in advance, and the lower threshold Ee is updated by referring to the map.

On the other hand, as illustrated in FIG. 13G, a map in which the pulsation amplitude Pa and the pulsation frequency F and the reference value of the lower threshold Ee are associated with each other may be stored in the memory in advance, and the lower threshold Ee may be updated by referring to the map.

A map in which at least one of the pulsation amplitude Pa, the pulsation frequency F, or the average air amount Gave is associated with the reference value of the lower threshold Ee may be stored in the memory in advance, and the lower threshold Ee may be updated by referring to the map.

### (Second Embodiment)

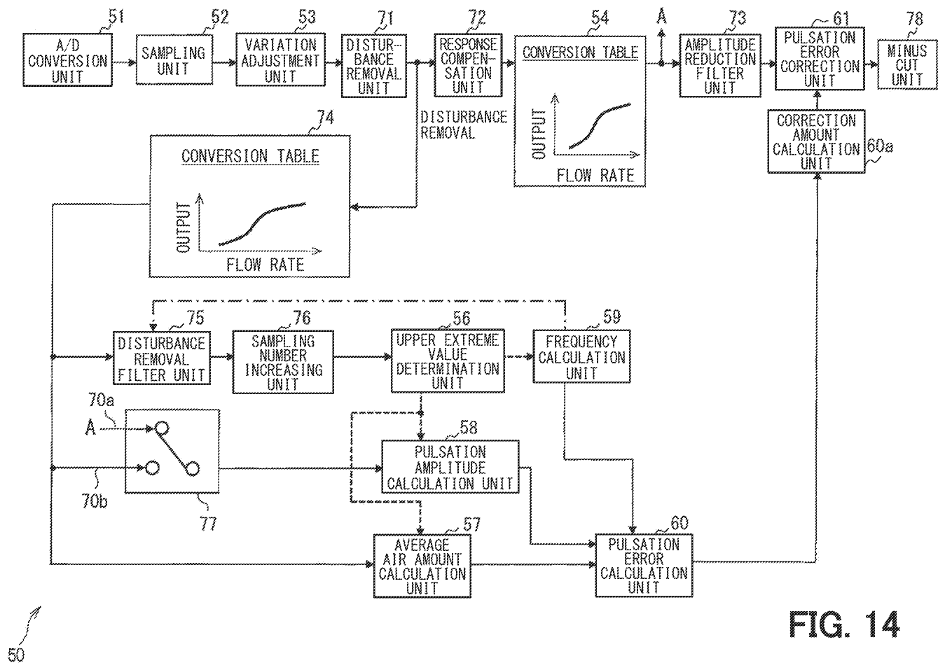

A measurement control device according to a second embodiment will be described with reference to FIGS. 14 to 16. In the first embodiment, the correction circuit 50 has only one path for inputting the output value of the sensing unit 22 to the pulsation amplitude calculation unit 58, but in the second embodiment, there are two routes to input the output value to the pulsation amplitude calculation unit 58. In the present embodiment, differences from the first embodiment will be mainly described.

As illustrated in FIG. 14, the correction circuit 50 has a first path 70a that inputs an output value converted in the first conversion table 54 to the pulsation amplitude calculation unit 58, and a second path 70b that inputs an output value before conversion in the first conversion table 54 to the pulsation amplitude calculation unit 58. In FIG. 14, an illustration of a part of the first path 70a is omitted by a symbol A.

In addition to the same functional blocks as those in the first embodiment, the correction circuit 50 includes a disturbance removal unit 71, a response compensation unit 72, an amplitude reduction filter unit 73, a second conversion table 74, a disturbance removal filter unit 75, a sampling number increasing unit 76, a switch unit 77, and a minus cut unit 78. In the second embodiment, a conversion table 54 substantially the same as that described in the first embodiment will be referred to as a first conversion table 54, and a conversion table 74 to be described in the second embodiment will be referred to as a second conversion table 74.

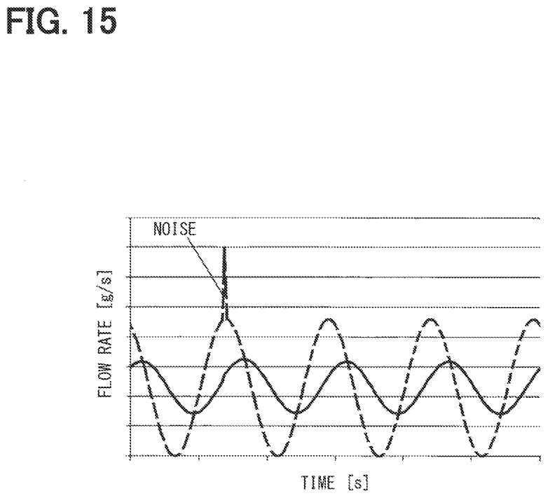

The disturbance removal unit 71 is a functional block that is provided between the variation adjustment unit 53 and the first conversion table 54, and to which an output value processed by the variation adjustment unit 53 is input. The disturbance removal unit 71 is a sudden change limiting unit that limits a sudden change in the output value so large that the rate of change with respect to the output value at previous time exceeds a predetermined reference value, and limits the change amount to a predetermined value, for example. For example, when noise illustrated in FIG. 15 is included in the output value, this noise is removed by the disturbance removal unit 71.

The response compensation unit 72 is a functional block that is provided between the disturbance removal unit 71 and the first conversion table 54, and to which an output value processed by the disturbance removal unit 71 is input. The response compensation unit 72 is a filter that causes the output value to faithfully reproduce a sudden change in the air flow rate actually detected by the sensing unit 22, and is formed by, for example, a high-pass filter. An output value compensated by the response compensation unit 72 has a state in which the response is advanced in time and the frequency range is wider than the output value before compensation.

The amplitude reduction filter unit 73 is a functional block that is provided between the first conversion table 54 and the pulsation error correction unit 61, and to which an output value processed by the first conversion table 54 is input. The amplitude reduction filter unit 73 is a filter unit that blunts and reduces the pulsation amplitude Pa of the output value, and is formed by, for example, a low-pass filter. Processing of the amplitude reduction filter unit 73 is performed after processing of the first conversion table 54, and thus the average air amount Gave calculated using the output value does not change.

The first path 70a is connected between the first conversion table 54 and the pulsation error correction unit 61, and the second path 70b is connected between the disturbance removal unit 71 and the response compensation unit 72. Both of these paths 70a and 70b are connected to the pulsation amplitude calculation unit 58 via the switch unit 77. The switch unit 77 is a switching unit that selectively connects the first path 70a and the second path 70b to the pulsation amplitude calculation unit 58. When the switch unit 77 is in a first state, the pulsation amplitude calculation unit 58 is connected to the first path 70a but is blocked from the second path 70b. When the switch unit 77 is in a second state, the pulsation amplitude calculation unit 58 is connected to the second path 70b but is blocked from the first path 70a.

The switch unit 77 is set to one of the first state and the second state at the time of manufacturing the air flow meter 10, and basically holds the state after being mounted on the vehicle. The state of the switch unit 77 may be switched according to the engine operating state or the like after being mounted on the vehicle.

The second conversion table 74 is a functional block that is provided between the disturbance removal unit 71 and the switch unit 77 in the second path 70b, and to which an output value processed by the disturbance removal unit 71 is input. Unlike the first conversion table 54, the second conversion table 74 converts a sampling value acquired by the sampling unit 52 into an air flow rate at a stage before processing of the response compensation unit 72 is performed.

The disturbance removal filter unit 75 is a functional block that is provided between the second conversion table 74 and the upper extreme value determination unit 56 in the path branched from the second path 70b, and to which an output value processed by the second conversion table 74 is input. The disturbance removal filter unit 75 is a filter unit that blunts and removes an output value contained in a higher-order component that is a harmonic component, and is formed by, for example, a low-pass filter. The disturbance removal filter unit 75 can variably set a filter constant.

The sampling number increasing unit 76 is a functional block that is provided between the disturbance removal filter unit 75 and the upper extreme value determination unit 56, and to which an output value processed by the disturbance removal filter unit 75 is input. The sampling number increasing unit 76 is an up-sampling unit that increases the sampling value acquired by the sampling unit 52, and has a higher time resolution than the sampling unit 52. The sampling number increasing unit 76 is formed by a filter such as a variable filter or a CIC filter.

The upper extreme value determination unit 56 determines whether or not the sampling value converted in the conversion table 54 is an upper extreme value Ea. The upper extreme value Ea is a sampling value at a timing when the output value switches from increase to decrease.

When the output value remains to be more than the predetermined lower threshold Ee during a period from a timing when the upper extreme value Ea has previously appeared to a timing when the upper extreme value Ea has presently appeared in the waveform representing a time change of the output value, the upper extreme value determination unit 56 negatively determines and cancels the upper extreme value Ea that has presently appeared. Moreover, the upper extreme value determination unit 56 specifies the reference value of the lower threshold Ee by referring to the map in which the pulsation amplitude Pa, the pulsation frequency F, and the average air amount Gave are associated with the reference value of the lower threshold Ee, and the lower threshold Ee is updated on the basis of the reference value of this lower threshold.

The frequency calculation unit 59 adds the calculated pulsation frequency F to the pulsation error calculation unit 60 and outputs the calculated pulsation frequency F to the disturbance removal filter unit 75. The disturbance removal filter unit 75 feedback-controls an optimum filter constant using the pulsation frequency F from the frequency calculation unit 59.

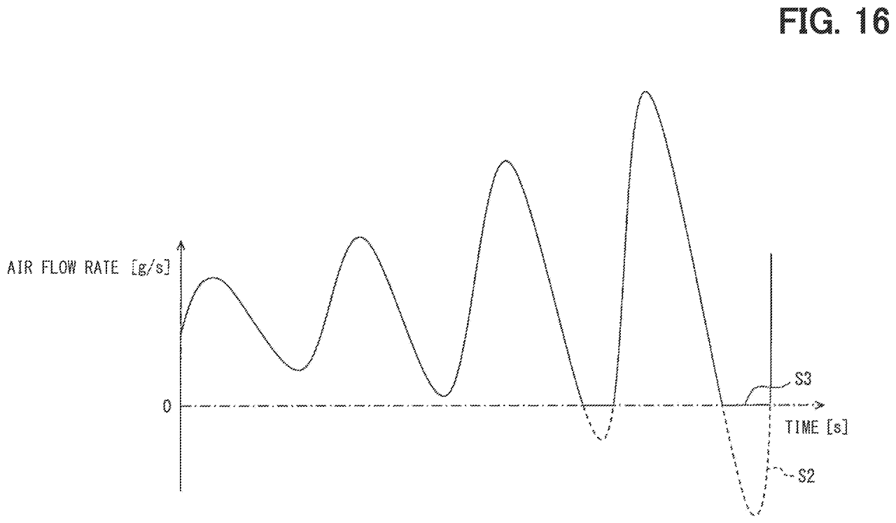

The minus cut unit 78 cuts a minus output value S2 out of the output value S2 after correction, and calculates an output value S3 after cutting. As illustrated in FIG. 16, when the output value S2 after correction contains a minus value, which is a negative value, the minus value is cut by the minus cut unit 78 to be zero, so that the output value S3 after cutting does not contain any negative values. On the other hand, for a plus value, which is a positive value, the output value S2 after correction and the output value S3 after cutting are the same values. As described above, in the housing 21, the measurement outlet 36 is provided at a position where a backflow generated in the intake passage 12 is less likely to flow in from the measurement outlet 36, but when entrance of the backflow from the measurement outlet 36 does not always become zero. In this case, the air flow rate of the backflow entering from the measurement outlet 36 becomes unstable, and it becomes difficult to measure the air flow rate with high accuracy. Accordingly, by performing processing of the minus cut unit 78, the measurement accuracy of the air flow rate can be improved.

In the correction circuit 50, in addition to the average air amount Gave2 after correction calculated by the pulsation error correction unit 61 and the output value S2 after correction, the output value S3 after cutting calculated by the minus cut unit 78 is output to the output circuit 62. The output circuit 62 outputs an average air amount Gave2 after correction, the output value S2 after correction, and the output value S3 after correction to the ECU 46.

In the present embodiment, similar effects exhibited by components common to the above-described first embodiment can be obtained as in the first embodiment.

The measurement control device of the present embodiment includes a disturbance removal filter unit 75 that removes a predetermined frequency component from the signal output from the sensing unit 22. The upper extreme value determination unit 56 specifies the lower threshold Ee using the output value of the signal transmitted through the disturbance removal filter unit 75.

Therefore, even when high frequency noise is added to the output value of the sensing unit 22, it is possible to specify the lower threshold Ee without being affected by the high frequency noise.

The disturbance removal filter unit 75 includes a low-pass filter that removes high-frequency components. In this manner, the disturbance removal filter unit 75 can include a low-pass filter.

### (Third Embodiment)

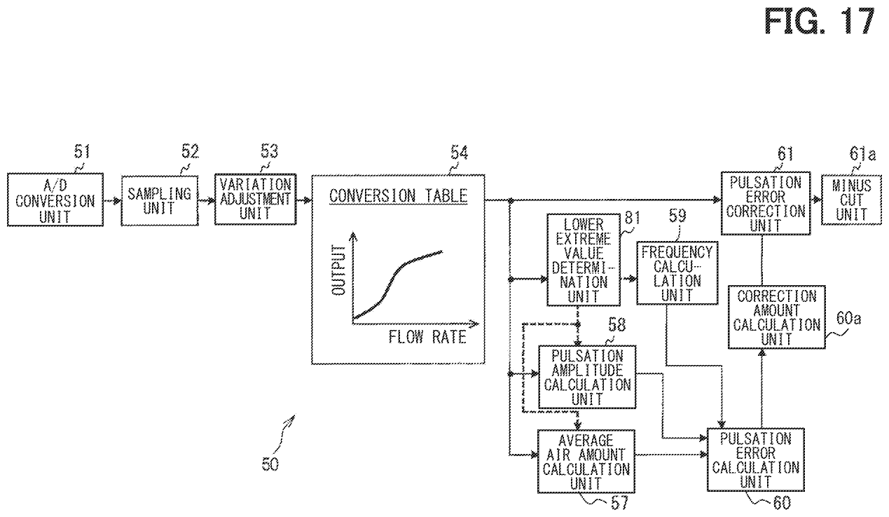

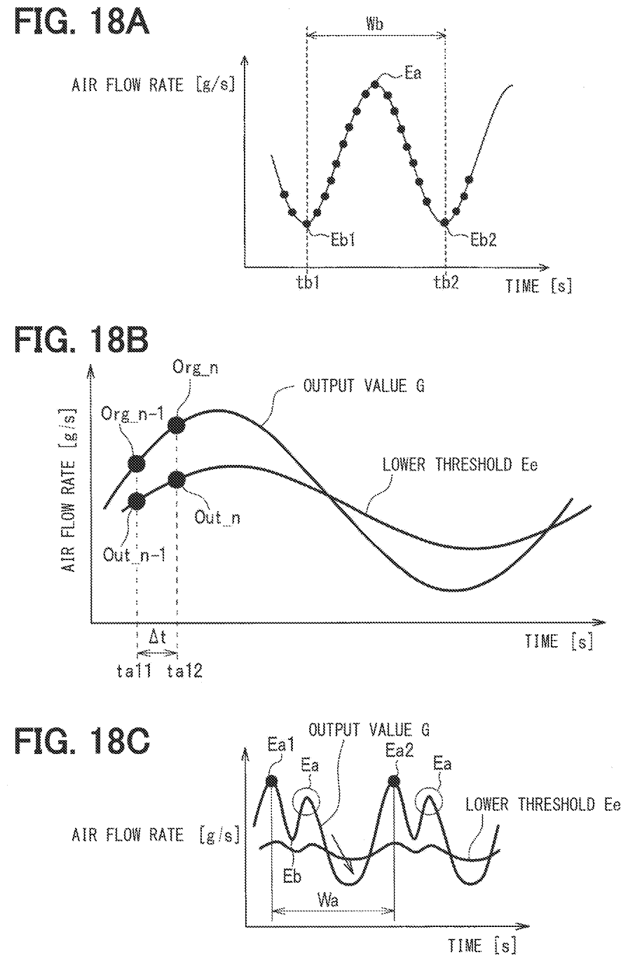

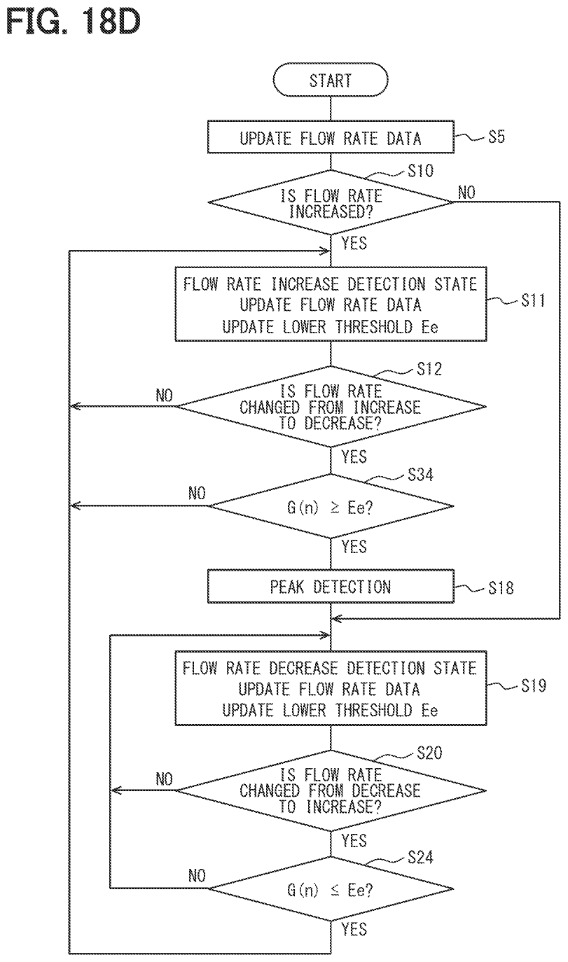

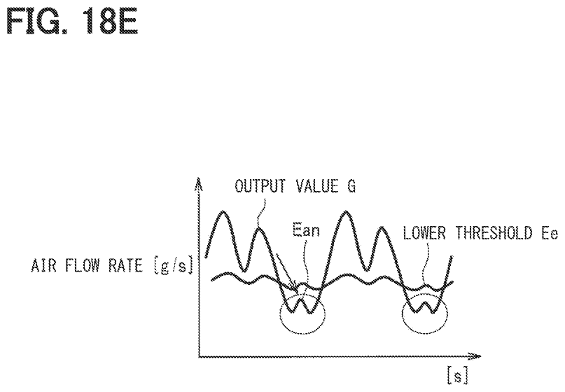

A measurement control device according to a third embodiment will be described with reference to FIGS. 17 to 18A. In the first embodiment, the correction circuit 50 has the upper extreme value determination unit 56, but in the third embodiment, the correction circuit 50 has a lower extreme value determination unit 81. In the present embodiment, differences from the first embodiment will be mainly described.

As illustrated in FIG. 17, the lower extreme value determination unit 81 is provided between the conversion table 54 and the frequency calculation unit 59 in the correction circuit 50. The lower extreme value determination unit 81 determines whether or not a sampling value processed by the conversion table 54 is a lower extreme value Eb. As described above, the lower extreme value Eb is the sampling value at a timing when an output value switches from decrease to increase. The lower extreme value determination unit 81 acquires a timing when the sampling value becomes the lower extreme value Eb as the lower extreme timing tb, and causes the lower extreme value Eb to be stored in the storage device of the processing unit 45. The lower extreme value determination unit 81 outputs information including the lower extreme timing tb as timing information indicating a pulsation cycle to the average air amount calculation unit 57, the pulsation amplitude calculation unit 58, and the frequency calculation unit 59. The fact that the output value becomes the lower extreme value Eb corresponds to a specific condition, and the lower extreme value determination unit 81 and the frequency calculation unit 59 correspond to the pulsation state calculation unit.

The lower extreme value determination unit 81 determines whether or not the sampling value converted in the conversion table 54 is the lower extreme value Eb. The lower extreme value Eb is the sampling value at the timing when the output value switches from decrease to increase.

When the output value remains to be less than a predetermined upper threshold Ef during a period from a timing when the lower extreme value Eb has previously appeared to a timing when the lower extreme value Eb has presently appeared in the waveform representing a time change of the output value, the lower extreme value determination unit 81 negatively determines and cancels the lower extreme value Eb that has presently appeared. Further, the lower extreme value determination unit 81 specifies a reference value of the lower threshold Ee on the basis of the physical quantity, the pulsation frequency F, and the pulsation amplitude Pa that correlate with the average air amount Gave, and updates the lower threshold Ee on the basis of the reference value of the lower threshold Ee. The lower extreme value determination unit 81, as does the upper extreme value determination unit 56, causes a map in which the pulsation amplitude Pa, the pulsation frequency F, and the average air amount Gave and a reference value of the upper threshold Ef are associated with each other to be stored in the memory in advance, and updates the upper threshold Ef by referring to the map. Specifically, the reference value of the upper threshold Ef corresponding to the pulsation amplitude Pa, the pulsation frequency F, and the average air amount Gave is updated as a new upper threshold Ef.

The frequency calculation unit 59 uses the timing information from the lower extreme value determination unit 81 to calculate an interval at which the sampling value becomes the lower extreme value Eb as a lower extreme interval Wb, and uses this lower extreme interval Wb to calculate the pulsation frequency F. For example, as illustrated in FIG. 18A, when the sampling value becomes the lower extreme value Eb and then the sampling value becomes the next lower extreme value Eb, the previous lower extreme value Eb will be referred to as the first lower extreme value Eb1, and the next lower extreme value Eb will be referred to as the second lower extreme value Eb2. In this case, the frequency calculation unit 59 uses a first lower extreme timing tb1 at which the sampling value becomes the first lower extreme value Eb1 and a second lower extreme timing tb2 at which the sampling value becomes the second lower extreme value Eb2, to calculate the lower extreme interval Wb that is the interval between the lower extreme timings tb1 and tb2. For example, the pulsation frequency F is calculated using the relationship F[Hz]=1/Wb[s].

For the period from the first lower extreme timing tb1 to the second lower extreme timing tb2, the minimum pulsation value Gmin is the smaller one of the first lower extreme value Eb1 and the second lower extreme value Eb2. When these lower extreme values Eb1 and Eb2 are the same value, that value becomes the minimum pulsation value Gmin. The average value of the first lower extreme value Eb1 and the second lower extreme value Eb2 may be the minimum pulsation value Gmin.

As described above, the measurement control device of the present embodiment includes the sensing unit 22 that outputs a signal according to the air flow rate and a pulsation state calculation unit that calculates a pulsation state that is a state of pulsation generated in the air flow rate using the output value of the sensing unit 22. The measurement control device includes a pulsation error correction unit 61 that corrects the air flow rate using the pulsation state calculated by the pulsation state calculation unit. The pulsation state calculation unit has a lower extreme value determination unit 81 that, when the output value when a change mode of the output value switches from decrease to increase is referred to as the lower extreme value Eb, determines whether or not the output value has become the lower extreme value Eb. When the output value remains to be less than the predetermined upper threshold Ef during a period from a timing when the lower extreme value Eb has previously appeared to a timing when the lower extreme value Eb has presently appeared in the waveform representing a time change of the output value, the lower extreme value determination unit 81 negatively determines and cancels the lower extreme value Eb that has presently appeared. Moreover, the upper threshold Ef is updated on the basis of at least one of the air flow rate specified on the basis of the output value, the pulsation frequency F specified on the basis of the output value, or the pulsation amplitude Pa specified on the basis of the output value.

With such a configuration, the upper threshold Ef is updated on the basis of at least one of the air flow rate specified on the basis of the output value, the pulsation frequency F specified on the basis of the output value, or the pulsation amplitude Pa specified on the basis of the output value, and thus false detection of the lower extreme value Eb is reduced. Therefore, the correction accuracy of the air flow rate can be improved.

The measurement control device includes the sensing unit 22 that outputs a signal according to the air flow rate, and a pulsation state calculation unit that calculates a pulsation state that is a state of pulsation generated in the air flow rate using the output value of the sensing unit 22. The measurement control device includes a pulsation error correction unit 61 that corrects the air flow rate using the pulsation state calculated by the pulsation state calculation unit. The pulsation state calculation unit has a lower extreme value determination unit 81 that, when the output value when a change mode of the output value switches from decrease to increase is referred to as the lower extreme value Eb, determines whether or not the output value has become the lower extreme value Eb. The pulsation state calculation unit has a frequency calculation unit 59 that calculates the pulsation frequency F of the pulsation generated in the air flow rate on the basis of the time interval in which the output value becomes the lower extreme value Eb. When the output value remains to be less than the predetermined upper threshold Ef during a period from a timing when the lower extreme value has previously appeared to a timing when the lower extreme value has presently appeared in the waveform representing a time change of the output value, the lower extreme value determination unit 81 negatively determines and cancels the lower extreme value that has presently appeared. Moreover, the lower extreme value determination unit 81 updates the upper threshold Ef on the basis of the reference value of the upper threshold Ef that changes according to the pulsation state.

With such a configuration, the upper threshold Ef is updated on the basis of the reference value of the upper threshold Ef that changes according to the pulsation state, and thus false detection of the lower extreme value Eb is reduced. Therefore, the correction accuracy of the air flow rate can be improved.

### (Fourth Embodiment)

A measurement control device according to a fourth embodiment will be described. The upper extreme value determination unit 56 of the first embodiment causes a map in which the pulsation amplitude Pa, the pulsation frequency F, and the average air amount Gave and the reference value of the lower threshold Ee are associated with each other to be stored in the memory in advance, and updates the lower threshold Ee by referring to the map thereof.

On the other hand, the upper extreme value determination unit 56 of the present embodiment causes a function that takes at least one of the pulsation amplitude Pa, the pulsation frequency F, or the average air amount Gave as a variable, and calculates the lower threshold Ee to be stored in the memory in advance, and updates the lower threshold Ee using the function. In this manner, the upper extreme value determination unit 56 can also update the lower threshold Ee using a function.

### (Fifth Embodiment)

A measurement control device according to a fifth embodiment will be described. The measurement control device of the present embodiment has the same configuration as that of the measurement control device of the first embodiment. The upper extreme value determination unit 56 of the first embodiment updates the lower threshold Ee using a map in which the pulsation amplitude Pa, the pulsation frequency F, and the average air amount Gave are associated with the reference value of the lower threshold Ee. On the other hand, the upper extreme value determination unit 56 of the present embodiment updates the lower threshold Ee by using the lower threshold Ee used for determining the upper extreme value Ea in a period from before the predetermined period to the timing when the upper extreme value Ea has presently appeared. In the following description, the reference sign Ee of the lower threshold may be omitted.

As illustrated in FIG. 18B, an output value of the sensing unit 22 at a predetermined timing ta11 is Org_n−1, and a lower threshold at the predetermined timing ta11 is Out_n−1. An output value of the sensing unit 22 at a timing ta12 after a sampling interval Δt has elapsed from the predetermined timing ta11 is Org_n, and a lower threshold is Out_n, a sampling interval is Δt, and a time constant is T at the timing ta12. In the following description, the timing ta12 after the sampling interval Δt has elapsed from the predetermined timing ta11 is referred to as “present timing ta12” for convenience of description.

The upper extreme value determination unit 56 calculates the lower threshold Out_n at the present timing ta12 using Mathematical Expression 1 below.

[Expression 1]

Out_n=(Org_n−Out_n−1)×(1−e^{(-Δt/T)})+Out_n−1 Mathematical Expression 1

The upper extreme value determination unit 56 updates the lower threshold Out_n at the present timing ta12 to a value calculated using Mathematical Expression 1. A timing for updating the lower threshold is the same as S11 and S19 in FIG. 13F.

The lower threshold Out_n at the present timing ta12 is updated on the basis of a difference between the output value Org_n of the sensing unit 22 at the present timing ta12 and the lower threshold Out_n−1 at the predetermined timing ta11.

The lower threshold Out_n is a value obtained by applying a first-order response delay to the output value of the sensing unit 22. That is, the lower threshold Out_n is updated so as to slowly follow the output value of the sensing unit 22 while being delayed.

FIG. 18C illustrates waveforms of the output value G of the sensing unit 22 and the lower threshold Ee updated using Mathematical Expression 1. As illustrated in FIG. 18C, the lower threshold Ee changes so as to follow the output value G of the sensing unit 22. The lower extreme value Eb and the upper extreme value Ean in FIG. 18C are due to harmonic noise.

As illustrated in FIG. 18C, the lower extreme value Eb remains to be more than the predetermined lower threshold Ee by updating the lower threshold Out_n so as to follow the output value G of the sensing unit 22. Therefore, the upper extreme value determination unit 56 negatively determines and cancels the upper extreme value Ean due to the harmonic noise. Therefore, the toughness against harmonic noise can be improved.

As described above, the measurement control device of the present embodiment includes the sensing unit 22 that outputs a signal according to the air flow rate and a pulsation state calculation unit that calculates a pulsation state that is a state of pulsation generated in the air flow rate using the output value of the sensing unit 22. The measurement control device includes a pulsation error correction unit 61 that corrects the air flow rate using the pulsation state calculated by the pulsation state calculation unit. The pulsation state calculation unit has an upper extreme value determination unit 56 that, when the output value when a change mode of the output value switches from increase to decrease is referred to as an upper extreme value Ea, determines whether or not the output value has become the upper extreme value Ea. The pulsation state calculation unit has the frequency calculation unit 59 that calculates the pulsation frequency F of the pulsation generated in the air flow rate on the basis of a time interval at which the output value becomes the upper extreme value Ea. When the output value remains to be more than the predetermined lower threshold Ee during a period from a timing when the upper extreme value Ea has previously appeared to a timing when the upper extreme value Ea has presently appeared in the waveform representing a time change of the output value, the upper extreme value determination unit 56 negatively determines and cancels the upper extreme value Ea that has presently appeared. Moreover, the upper extreme value determination unit 56 updates the lower threshold Ee by using the lower threshold Ee used for determining the upper extreme value Ea in a period from before a predetermined period to the timing when the upper extreme value has presently appeared.

With such a configuration, the lower threshold Ee is updated by using the lower threshold Ee used for determining the upper extreme value Ea in a period from before the predetermined period to a timing when the upper extreme value Ea has presently appeared, and thus false detection of the extreme value Ea is reduced. Therefore, the correction accuracy of the air flow rate can be improved.

The measurement control device of the present embodiment includes the sampling unit 52 that samples output values at a predetermined sampling interval. When the output value remains to be more than the lower threshold Ee during the period from the timing when the upper extreme value has previously appeared to the timing when the upper extreme value has presently appeared in a waveform representing a time change of the output value, the upper extreme value determination unit 56 negatively determines and cancels the upper extreme value that has presently appeared. Further, the measurement control device updates the lower threshold Out_n used to determine the output value at present time on the basis of a difference between the output value Org_n at present time sampled by the sampling unit 52 and the lower threshold Out_n−1 used at a time of determining the output value at previous time sampled by the sampling unit 52.

In this manner, the lower threshold Out_n used to determine the output value at present time can be updated on the basis of a difference between the output value Org_n at present time sampled by the sampling unit 52 and the lower threshold Out_n−1 used at a time of determining the sampled output value at previous time.

### (Sixth Embodiment)

A measurement control device according to a sixth embodiment will be described with reference to FIGS. 18D and 18E. In the first embodiment, when an affirmative determination is made in step S12 of FIG. 13F, the process proceeds to step S18. On the other hand, in the present embodiment, if an affirmative determination is made in step S12 of FIG. 18D, the process proceeds to step S34. In step S34, it is determined whether or not the sampling value at present time is equal to or higher than the lower threshold Ee during the period from a timing when the upper extreme value Ea has previously appeared to a timing when the upper extreme value Ea has presently appeared in the waveform representing the time change of the output value.

When the sampling value at present time remains to be less than the lower threshold Ee in step S34, the process returns to step S11 to update the flow rate data and the lower threshold Ee. That is, the upper extreme value Ean that has presently appeared is negatively determined and canceled.

When the sampling value at present time is equal to or higher than the lower threshold Ee, the process proceeds to the next step S18, and the sampling value at present time is detected as the upper extreme value Ea.

Therefore, as illustrated in FIG. 18E, when the upper extreme value Ean that has presently appeared is equal to or less than the lower threshold Ee, the upper extreme value Ean that has presently appeared is negatively determined and canceled.

As described above, when the output value becomes equal to or less than the lower threshold Ee during the period from the timing when the upper extreme value Ea has previously appeared to the timing when the upper extreme value Ea has presently appeared in the waveform representing the time change of the output value, the upper extreme value determination unit 56 negatively determines and cancels the upper extreme value Ean that has presently appeared.

Therefore, when the output value becomes equal to or less than the lower threshold Ee, the upper extreme value Ean appearing this time can be prevented from being recognized as the upper extreme value Ea.

### (Seventh Embodiment)

A measurement control device according to a seventh embodiment will be described. In the measurement control device of the present embodiment, the frequency calculation unit 59 calculates a pulsation frequency average value, which is an average of the pulsation frequency F during a period from before a predetermined period to the timing when the upper extreme value Ea has presently appeared. The pulsation error correction unit 61 corrects the air flow rate using the pulsation frequency average value calculated by the frequency calculation unit 59.

In this manner, by calculating the pulsation frequency average value, which is the average of the pulsation frequency F during the period from before the predetermined period to the timing when the upper extreme value Ea has presently appeared, robustness against minute fluctuations in the pulsation frequency F can be improved. Influence of noise on the output value of the sensing unit 22 can be reduced.

### (Eighth Embodiment)

A measurement control device according to an eighth embodiment will be described. In the measurement control device of the present embodiment, the frequency calculation unit 59 calculates a median value of the pulsation frequency F during a period from before a predetermined period to the timing when the upper extreme value Ea has presently appeared. The pulsation error correction unit 61 corrects the air flow rate using the median value of the pulsation frequency F calculated by the frequency calculation unit 59.

In this manner, by calculating the median value of the pulsation frequency F during the period from before the predetermined period to the timing when the upper extreme value Ea has presently appeared, robustness against minute fluctuation of the pulsation frequency F can be improved. Influence of noise on the output value of the sensing unit 22 can be reduced.

### (Ninth Embodiment)

A measurement control device according to a ninth embodiment will be described. In the sixth embodiment, when the output value becomes equal to or less than the lower threshold Ee during a period from before the predetermined period to a timing when the upper extreme value Ea has presently appeared, the upper extreme value determination unit 56 negatively determines and cancels the upper extreme value Ean that has presently appeared. On the other hand, in the present embodiment, the lower extreme value determination unit 81 is provided in place of the upper extreme value determination unit 56, and the lower extreme value determination unit 81 updates the upper threshold using the upper threshold used for determining the lower extreme value during a period from before a predetermined period to a timing when the lower extreme value has presently appeared.

The measurement control device of the present embodiment has a sensing unit 22 that outputs a signal according to the air flow rate, and a pulsation state calculation unit that calculates a pulsation state that is a state of pulsation generated in the air flow rate by using the output value of the sensing unit 22.

The measurement control device includes a pulsation error correction unit 61 that corrects the air flow rate using the pulsation state calculated by the pulsation state calculation unit.

The pulsation state calculation unit has a lower extreme value determination unit 81 that, when the output value when a change mode of the output value switches from decrease to increase is referred to as the lower extreme value Eb, determines whether or not the output value has become equal to or more than the lower extreme value Eb. The pulsation state calculation unit has a frequency calculation unit 59 that calculates the pulsation frequency F of the pulsation generated in the air flow rate on the basis of the time interval in which the output value becomes the lower extreme value Eb.

When the output value remains to be less than the predetermined upper threshold Ef during the period from the timing when the lower extreme value Eb has previously appeared to the timing when the lower extreme value Eb has presently appeared in the waveform representing the time change of the output value, the lower extreme value determination unit 81 negatively determines and cancels the lower extreme value Eb that has presently appeared. Moreover, the upper threshold Ef is updated by using the upper threshold Ef used for determining the lower extreme value Eb in the period from before the predetermined period to the timing when the lower extreme value Eb has presently appeared.

With such a configuration, the upper threshold Ef is updated by using the upper threshold Ef used for determining the lower extreme value Eb in the period from before the predetermined period to the timing when the lower extreme value Eb has presently appeared, and thus false detection of the lower extreme value Eb is reduced. Therefore, the correction accuracy of the air flow rate can be improved.

### (Other Embodiments)

Although the plurality of embodiments according to the present disclosure has been described above, the present disclosure is not construed as being limited to the above embodiments, and can be applied to various embodiments and combinations within the scope of the gist of the present disclosure.

As modification 1, the measurement outlet 36 may face the opposite side of the inflow port 33 as does the outflow port 34. For example, the measurement outlet 36 is provided between the inflow port 33 and the outflow port 34 in the depth direction Z. In this configuration, the measurement outlet 36 is formed on a convex portion protruding in the width direction X from an outer peripheral surface of the housing 21, the measurement outlet 36 is open toward a downstream side of the intake passage 12 as is the case with the outflow port 34. In the intake passage 12, air flowing in the forward direction along the outer peripheral surface of the housing 21 passes through the measurement outlet 36, so that turbulence of air flow such as a vortex is likely to occur around the measurement outlet 36. Thus, even if the measurement outlet 36 faces the opposite side of the inflow port 33, it is conceivable that this backflow is less likely to flow into the measurement outlet 36 when an air backflow occurs at the intake passage 12.

On the other hand, also in this modification, the pulsation error Err is calculated using the pulsation amplitude Pa. Thus, even if the backflow is less likely to flow into the measurement outlet 36 and the correction accuracy of the air flow rate is likely to decrease, the correction accuracy can be improved as in the first embodiment. In the first embodiment, the measurement outlet 36 may be provided in the downstream outer surface 24c, so as to be open toward the side opposite to the inflow port 33.

As modification 2, in the housing 21, a part of the measurement outlet 36 is provided in the upstream outer surface 24b and the rest is not provided in the intermediate outer surface 24d, but the entire measurement outlet 36 may be provided on the upstream outer surface 24b or the intermediate outer surface 24d. When the entire measurement outlet 36 is provided in the upstream outer surface 24b, a configuration in which the measurement outlet 36 is open toward the opposite side of the outflow port 34 is achieved. When the entire measurement outlet 36 is provided in the intermediate outer surface 24d, a configuration in which the measurement outlet 36 is open in the width direction X is achieved. In this configuration, the opening direction of the measurement outlet 36 is different from both the opening direction of the inflow port 33 and the opening direction of the outflow port 34.

As modification 3, the bypass passage 30 may have the measurement path 32 but does not necessarily have the passage path 31. In this case, the measurement inlet 35 is formed on the outer surface of the housing 21, and the air flowing through the intake passage 12 flows from the measurement inlet 35 into the bypass passage 30.

As modification 4, if at least a part of a narrow portion such as the detection narrow portion 37 is provided upstream of the sensing unit 22 in the measurement path 32, the narrow portion may be provided in the branch path 32a or the guide path 32b. The detection narrow portion 37 may have a pair of extension surfaces extending from an inner wall surface of the housing body 24 toward the sensing unit 22 in the width direction X, and a flat surface extending over these extension surfaces and extending straight in the depth direction Z. The extension surface may be a surface extending straight in the width direction X, or may be a surface extending straight in a direction inclined with respect to the width direction X. The extension surface may be a curved surface curved so as to bulge outward, or may be a curved surface curved so as to be recessed toward the inside. The detection narrow portion 37 may have only the extension surface on the upstream side of the pair of extension surfaces. In this configuration, the flat surface extends to a downstream side of the detection path 32c.

As modification 5, the correction amount calculation unit 60a may calculate the correction amount Q in the same unit as the output value S1 before correction such as the offset amount, instead of the correction amount Q indicating the correction ratio such as the gain amount. In this case, the pulsation error correction unit 61 calculates the output value S2 after correction by adding the correction amount Q to the output value S1 before correction. In the sixth embodiment, the correction amount calculation unit 60a may calculate the correction amount Q in the same unit as the average air amount Gave 1 before correction. In this case, the pulsation error correction unit 61 calculates the average air amount Gave3 after correction by adding the correction amount Q to the average air amount Gave1 before correction.

As modification 6, the correction circuit 50 includes at least two of the upper extreme value determination unit 56 of the first embodiment, the lower extreme value determination unit 81 of the third embodiment, an increase threshold determination unit 82 of the fourth embodiment, or a decrease threshold determination unit 83 of the fifth embodiment may be provided. In this case, the frequency calculation unit 59 calculates the pulsation frequency F for each of determination results of at least two of the upper extreme value determination unit 56, the lower extreme value determination unit 81, the increase threshold determination unit 82, or the decrease threshold determination unit 83, and calculates the pulsation frequency F by taking an average of these pulsation frequencies F, or the like.

As modification 7, the processing unit 45 may process the output value from the sensing unit 22 by a map, a function, a fast Fourier transform, or the like to calculate the pulsation frequency F.

As modification 8, bidirectional communication may be possible between the ECU 46 and the processing unit 45. For example, the ECU 46 may output external information such as engine parameters to the processing unit 45. Also in this case, the processing unit 45 calculates the pulsation state such as the pulsation frequency F by using the output value of the sensing unit 22 instead of the external information.

As modification 9, the function achieved by the processing unit 45 may be achieved by hardware and software, or a combination thereof. The processing unit 45 may communicate with, for example, another control device, for example, the ECU 46, and the other control device may execute a part or all of the processing. When achieved by an electronic circuit, the processing unit 45 can be achieved by a digital circuit including a large number of logic circuits or an analog circuit.

As modification 10, in the first embodiment, the upper extreme value determination unit 56 updates the lower threshold Ee on the basis of the air flow rate, the pulsation frequency F, and the pulsation amplitude Pa, but the lower threshold Ee can also be updated on the basis of at least one of the air flow rate, the pulsation frequency F, and the pulsation amplitude Pa.

It should be appreciated that the present disclosure is not limited to the embodiments described above and can be modified appropriately. The embodiments above are not irrelevant to one another and can be combined appropriately unless a combination is obviously impossible. In the respective embodiments above, it goes without saying that elements forming the embodiments are not necessarily essential unless specified as being essential or deemed as being apparently essential in principle. In a case where a reference is made to the components of the respective embodiments as to numerical values, such as the number, values, amounts, and ranges, the components are not limited to the numerical values unless specified as being essential or deemed as being apparently essential in principle. Also, in a case where a reference is made to the components of the respective embodiments above as to shapes and positional relations, the components are not limited to the shapes and the positional relations unless explicitly specified or limited to particular shapes and positional relations in principle.

What is claimed is:

1. A measurement control device comprising:
a sensing unit configured to output a signal according to an air flow rate;
a pulsation state calculation unit configured to calculate a pulsation state that is a state of pulsation generated in the air flow rate using an output value of the sensing unit; and
a pulsation error correction unit configured to correct the air flow rate using the pulsation state calculated by the pulsation state calculation unit, wherein
the pulsation state calculation unit has
an upper extreme value determination unit configured to determine whether the output value has become an upper extreme value of the output value when the output value is changed from increase to decrease, and
a frequency calculation unit configured to calculate a pulsation frequency of the pulsation generated in the air flow rate on a basis of a time interval at which the output value becomes the upper extreme value, the pulsation state including the pulsation frequency, and
when the output value remains to be more than a predetermined lower threshold during a period from a timing when the upper extreme value has previously appeared to a timing when the upper extreme value has presently appeared in a waveform representing a time change of the output value, the upper extreme value determination unit is configured to cancel the upper extreme value that has presently appeared, and further update the lower threshold on a basis of at least one of the air flow rate specified on a basis of the output value, the pulsation frequency, or a pulsation amplitude specified on the basis of the output value.

2. The measurement control device according to claim 1, wherein the upper extreme value determination unit is configured to update the lower threshold using a map in which at least one of the air flow rate, the pulsation frequency, or the pulsation amplitude is associated with a reference value of the lower threshold.

3. A measurement control device comprising:
a sensing unit configured to output a signal according to an air flow rate;
a pulsation state calculation unit configured to calculate a pulsation state that is a state of pulsation generated in the air flow rate using an output value of the sensing unit; and
a pulsation error correction unit configured to correct the air flow rate using the pulsation state calculated by the pulsation state calculation unit, wherein
the pulsation state calculation unit has
an upper extreme value determination unit configured to determine whether the output value has become an upper extreme value of the output value when the output value is changed from increase to decrease, and
a frequency calculation unit configured to calculate a pulsation frequency of the pulsation generated in the air flow rate on a basis of a time interval at which the output value becomes the upper extreme value, the pulsation state including the pulsation frequency, and
when the output value remains to be more than a predetermined lower threshold during a period from a timing when the upper extreme value has previously appeared to a timing when the upper extreme value has presently appeared in a waveform representing a time change of the output value, the upper extreme value determination unit is configured to cancel the upper extreme value that has presently appeared, and further update the lower threshold on a basis of a reference value of the lower threshold that changes according to the pulsation state.

4. The measurement control device according to claim 3, wherein the upper extreme value determination unit is configured to update the lower threshold using a map in which the pulsation state is associated with the reference value of the lower threshold.

5. The measurement control device according to claim 3, wherein
when the output value remains to be more than a predetermined lower threshold during a period from a timing when the upper extreme value has previously appeared to a timing when the upper extreme value has presently appeared in a waveform representing a time change of the output value, the upper extreme value determination unit is configured to cancel the upper extreme value that has presently appeared, and further update the lower threshold by using the lower threshold used for determining the upper extreme value in a predetermined period to the timing when the upper extreme value has presently appeared.

6. The measurement control device according to claim 5, further comprising a sampling unit configured to sample the output value at a predetermined sampling interval, wherein
when the output value remains to be more than the lower threshold during the period from the timing when the upper extreme value has previously appeared to the timing when the upper extreme value has presently appeared in a waveform representing a time change of the output value, the upper extreme value determination unit is configured to cancel the upper extreme value that has presently appeared, and further update the lower threshold used to determine the output value at present time on a basis of a difference between the output value at present time sampled by the sampling unit and the lower threshold used at a time of determining the output value at previous time sampled by the sampling unit.

7. The measurement control device according to claim 1, further comprising a filter unit configured to remove a predetermined frequency component from the signal output from the sensing unit, wherein
the upper extreme value determination unit specifies the lower threshold by using the output value of the signal transmitted through the filter unit.

8. The measurement control device according to claim 7, wherein the filter unit includes a low-pass filter that removes high-frequency components.

9. The measurement control device according to claim 1, wherein the frequency calculation unit has a frequency limiting function that limits a change amount in the pulsation frequency to be equal to or less than a predetermined maximum frequency change amount.

10. The measurement control device according to claim 9, wherein the frequency calculation unit includes an operation unit configured to set enable or disable of the frequency limiting function.

11. The measurement control device according to claim 1, wherein
the frequency calculation unit calculates a pulsation frequency average value, which is an average of the pulsation frequency during a predetermined period to the timing when the upper extreme value has presently appeared, and
the pulsation error correction unit is configured to correct the air flow rate using the pulsation frequency average value calculated by the frequency calculation unit.

12. The measurement control device according to claim 1, wherein
the frequency calculation unit is configured to calculate a median value of the pulsation frequency during a predetermined period to the timing when the upper extreme value has presently appeared, and
the pulsation error correction unit is configured to correct the air flow rate using the median value of the pulsation frequency calculated by the frequency calculation unit.

13. The measurement control device according to claim 1, wherein
when the upper extreme value becomes equal to or less than the lower threshold during the period from the timing when the upper extreme value has previously appeared to the timing when the upper extreme value has presently appeared in the waveform representing the time change of the output value, the upper extreme value determination unit is configured to cancel the upper extreme value that has presently appeared.

14. A measurement control device comprising:
a sensing unit configured to output a signal according to an air flow rate;
a pulsation state calculation unit configured to calculate a pulsation state that is a state of pulsation generated in the air flow rate using an output value of the sensing unit; and
a pulsation error correction unit configured to correct the air flow rate using the pulsation state calculated by the pulsation state calculation unit, wherein
the pulsation state calculation unit has a lower extreme value determination unit configured to determine whether the output value has become a lower extreme value of the output value when the output value is changed from decrease to increase, and
when the output value remains to be less than a predetermined upper threshold during a period from a timing when the lower extreme value has previously appeared to a timing when the lower extreme value has presently appeared in a waveform representing a time change of the output value, the lower extreme value determination unit is configured to cancel the lower extreme value that has presently appeared, and further update the upper threshold on a basis of at least one of the air flow rate, a pulsation frequency, or a pulsation amplitude which are specified on a basis of the output value.

15. A measurement control device comprising:
a sensing unit configured to output a signal according to an air flow rate;
a pulsation state calculation unit configured to calculate a pulsation state that is a state of pulsation generated in the air flow rate using an output value of the sensing unit; and
a pulsation error correction unit configured to correct the air flow rate using the pulsation state calculated by the pulsation state calculation unit, wherein
the pulsation state calculation unit has
a lower extreme value determination unit configured to determine whether the output value has become a lower extreme value of the output value when the output value is changed from decrease to increase, and
a frequency calculation unit configured to calculate a pulsation frequency of the pulsation generated in the air flow rate on a basis of a time interval at which the output value becomes the lower extreme value, the pulsation state including the pulsation frequency, and
when the output value remains to be less than a predetermined upper threshold during a period from a timing when the lower extreme value has previously appeared to a timing when the lower extreme value has presently appeared in a waveform representing a time change of the output value, the lower extreme value determination unit is configured to cancel the lower extreme value that has presently appeared, and further update the upper threshold on a basis of a reference value of the upper threshold that changes according to the pulsation state.

16. The measurement control device according to claim 15, wherein
when the output value remains to be less than a predetermined upper threshold during a period from a timing when the lower extreme value has previously appeared to a timing when the lower extreme value has presently appeared in a waveform representing a time change of the output value, the lower extreme value determination unit is configured to cancel the lower extreme value that has presently appeared, and further update the upper threshold by using the upper threshold used for determining the lower extreme value in a predetermined period to the timing when the lower extreme value has presently appeared.
